(19) United States
(12) Patent Application Publication
(10) Pub. No.: US 2026/0128785 A1
(43) Pub. Date: May 7, 2026

(54) DEVICE AND METHOD FOR USE IN NON-TERRESTRIAL NETWORK

(71) Applicant: Sony Group Corporation, Tokyo (JP)

(72) Inventors: Mingtuo ZHOU, Shanghai (CN); Xiaoxue WANG, Beijing (CN); Haojin LI, Beijing (CN)

(73) Assignee: Sony Group Corporation, Tokyo (JP)

(21) Appl. No.: 19/121,810

(22) PCT Filed: Nov. 6, 2023
(86) PCT No.: PCT/CN2023/129913

§ 371 Date: Apr. 17, 2025

(30) Foreign Application Priority Data
Nov. 11, 2022 (CN) 202211408918.0

(51) Int. Cl. H04B 7/185; H04B 7/04

(52) U.S. Cl. CPC H04B 7/18547; H04B 7/04013; H04B 7/18532

(57) ABSTRACT

The present disclosure relates to devices and methods for use in non-terrestrial networks. A method for a user equipment in a non-terrestrial network is described. The non-terrestrial network includes a network device capable of communicating with the user equipment, a satellite, and a plurality of intelligent metasurfaces. The method may include: receiving system relevant information of the non-terrestrial network from the network device, the system relevant information including at least ephemeris information of the satellite, and identifiers and locations of one or more intelligent metasurfaces associated with the satellite among a plurality of intelligent metasurfaces; determining a path for the user equipment to communicate with the network device based at least on the received system relevant information, the determined path passing through one of the one or more intelligent metasurfaces; and communicating with the network device via the determined path.

### CLAIM OF PRIORITY

This application claims the priority to Chinese patent application with application number 202211408918.0, titled “DEVICE AND METHOD FOR USE IN NON-TERRESTRIAL NETWORK”, and filed on Nov. 11, 2022, which is incorporated herein by reference in its entirety.

### TECHNICAL FIELD

The present disclosure relates generally to devices and methods for use in non-terrestrial networks (NTNs), and particularly to techniques for path selection in a non-terrestrial network using intelligent metasurfaces.

### BACKGROUND

Wireless communication systems may use a variety of protocols and standards for data transmission between devices. These protocols and standards have undergone long developments, including but not limited to the 3rd Generation Partnership Project (3GPP), 3GPP Long Term Evolution (LTE) (for example, 4G communication), and 3GPP New Radio (NR) (for example, 5G communication) or even 6G communication. Compared with traditional wireless communication systems, new wireless communication systems (such as 5G NR communication systems and 6G communication systems) have been greatly improved in the speed, latency, capacity, flexibility and reliability of wireless transmission, and provide more possibilities for new usage patterns.

The new wireless communication systems have introduced high-frequency band communication (such as millimeter wave communication) technology, which are significantly affected by obstructions such as houses, human bodies, walls, or the like. In this regard, intelligent metasurfaces (also referred to as intelligent reflective surfaces/antennas) may be deployed between devices to act as relay nodes. For example, an intelligent reflective surface may be composed of a large number of low-cost micro-reflective elements, each of which may independently induce changes in amplitude and/or phase of a signal using software programming, thereby accurately controlling formation of a reflected beam. Therefore, the use of intelligent metasurfaces may significantly improve performance of the wireless communication networks at a lower cost.

On the other hand, the new wireless communication systems have introduced non-terrestrial network communications involving aerial communication stations such as satellites, so as to supplement the performance of terrestrial network communications. As an example, mobile operators may use the non-terrestrial networks to provide wireless communication services to areas short of infrastructures, and may provide wireless communication services to users as usual when the terrestrial networks are interrupted (in a scenario such as battlefield, earthquake or flood, outdoor, or the like.).

The non-terrestrial network communication and the intelligent metasurface technology are both relatively new technologies introduced in the 5G NR system or even the 6G system. Compared with using these two technologies independently, using both in combination can further improve the coverage and data transmission performance of non-terrestrial network communications in case of obstructions such as mountains, high buildings or the like. Therefore, it is desirable to find a system and a method that can transmit and receive signals effectively utilizing appropriate intelligent metasurface antennas in non-terrestrial network communications to improve the communication performance.

### SUMMARY

The present disclosure proposes a device and a method for use in a non-terrestrial network. More specifically, the present disclosure proposes a method for path selection in a non-terrestrial network using intelligent metasurfaces, wherein an appropriate intelligent metasurface is selected as a relay for non-terrestrial communication between devices in a variety of scenarios, thereby improving the accuracy and reliability of data transmission.

According to a first aspect of the present disclosure, there is provided an electronic device for a user equipment in a non-terrestrial network, wherein the non-terrestrial network further comprises a network device capable of communicating with the user equipment, a satellite and a plurality of intelligent metasurfaces, the electronic device comprising a processing circuit configured to cause the user equipment to: receive system relevant information of the non-terrestrial network from the network device, the system relevant information including at least ephemeris information of the satellite, and identifiers and locations of one or more intelligent metasurfaces associated with the satellite among the plurality of intelligent metasurfaces; determine a path for the user equipment to communicate with the network device based at least on the received system relevant information, the determined path going through one of the one or more intelligent metasurfaces; and communicate with the network device via the determined path.

Correspondingly, according to the first aspect of the present disclosure, there is provided a method for a user equipment in a non-terrestrial network, wherein the non-terrestrial network further comprises a network device capable of communicating with the user equipment, a satellite and a plurality of intelligent metasurfaces, the method comprising: receiving system relevant information of the non-terrestrial network from the network device, the system relevant information including at least ephemeris information of the satellite, and identifiers and locations of one or more intelligent metasurfaces associated with the satellite among the plurality of intelligent metasurfaces; determining a path for the user equipment to communicate with the network device based at least on the received system relevant information, the determined path going through one of the one or more intelligent metasurfaces; and communicating with the network device via the determined path.

According to a second aspect of the present disclosure, there is provided an electronic device for a network device in a non-terrestrial network, wherein the non-terrestrial network further comprises a user equipment capable of communicating with the network device, a satellite and a plurality of intelligent metasurfaces, the electronic device comprising a processing circuit configured to cause the network device to: acquire system relevant information of the non-terrestrial network, the system relevant information including at least ephemeris information of the satellite, and identifiers and locations of one or more intelligent metasurfaces associated with the satellite among the plurality of intelligent metasurfaces, wherein the one or more intelligent metasurfaces are determined by the network device based at least on a location of the satellite and the locations of the plurality of intelligent metasurfaces; and communicate with the user equipment via a determined path, wherein the path is determined based at least on the system relevant information, and the determined path goes through one of the one or more intelligent metasurfaces.

Correspondingly, according to the second aspect of the present disclosure, there is also provided a method for a network device in a non-terrestrial network, wherein the non-terrestrial network further comprises a user equipment capable of communicating with the network device, a satellite and a plurality of intelligent metasurfaces, the method comprising: acquiring system relevant information of the non-terrestrial network, the system relevant information including at least ephemeris information of the satellite, and identifiers and locations of one or more intelligent metasurfaces associated with the satellite among the plurality of intelligent metasurfaces, wherein the one or more intelligent metasurfaces are determined by the network device based at least on a location of the satellite and the locations of the plurality of intelligent metasurfaces; communicating with the user equipment via a determined path, wherein the path is determined based at least on the system relevant information, and the determined path goes through one of the one or more intelligent metasurfaces.

According to a third aspect of the present disclosure, there is provided a computer-readable storage medium having one or more instructions stored thereon, which, when executed by one or more processors of an electronic device, cause the electronic device to perform the methods according to various embodiments of the present disclosure.

According to a fourth aspect of the present disclosure, there is provided a computer program product including program instructions, which, when executed by one or more processors of a computer, cause the computer to perform the methods according to various embodiments of the present disclosure.

The above summary is provided to summarize some exemplary embodiments in order to provide a basic understanding to various aspects of the subject matter described herein. Therefore, the above features are merely examples and should not be construed as limiting the scope or spirit of the subject matter described herein in any way. Other features, aspects, and advantages of the subject matter described herein will become apparent from the detailed description described below in conjunction with the drawings.

### BRIEF DESCRIPTION OF THE DRAWINGS

A better understanding of the present disclosure can be obtained when the following detailed description of embodiments is considered in conjunction with accompanying drawings. The same or similar reference numbers are used throughout the drawings to denote the same or similar components. The accompanying drawings, along with the following detailed description, are incorporated in and constitute a part of this specification, to illustrate embodiments of the disclosure and to explain the principles and advantages of the disclosure. Wherein:

FIG. 1 is an application scenario diagram of an intelligent metasurface.

FIG. 2 illustrates an example scenario diagram of a non-terrestrial network using intelligent metasurfaces according to an embodiment of the present disclosure.

FIG. 3 illustrates an exemplary electronic device for a user equipment according to an embodiment of the present disclosure.

FIG. 4 illustrates an exemplary electronic device for a network device according to an embodiment of the present disclosure.

FIG. 5 illustrates an information interaction diagram for path selection in a non-terrestrial network using intelligent metasurfaces according to an embodiment of the present disclosure.

FIG. 6 illustrates a schematic diagram of a first embodiment for path selection in a non-terrestrial network using intelligent metasurfaces according to the present disclosure.

FIG. 7 illustrates an example diagram of a system information block in a first implementation for path selection in a non-terrestrial network using intelligent metasurfaces according to the present disclosure.

FIG. 8 illustrates an information interaction diagram of a first embodiment for path selection in a non-terrestrial network using intelligent metasurfaces according to the present disclosure.

FIG. 9 illustrates a schematic diagram of a second embodiment for path selection in a non-terrestrial network using intelligent metasurfaces according to the present disclosure.

FIGS. 10 and 11 illustrate information interaction diagrams of a second embodiment for path selection in a non-terrestrial network using intelligent metasurfaces according to the present disclosure.

FIG. 12 illustrates a schematic diagram of a third embodiment for path selection in a non-terrestrial network using intelligent metasurfaces according to the present disclosure.

FIG. 13 illustrates a flowchart of an example method for a user equipment in a non-terrestrial network according to an embodiment of the present disclosure.

FIG. 14 illustrates a flowchart of an example method for a network device in a non-terrestrial network according to an embodiment of the disclosure.

FIG. 15 is a block diagram of an example structure of a personal computer that may be employed as an information processing device in an embodiment of the present disclosure;

FIG. 16 is a block diagram showing a first example of a schematic configuration of a base station to which the technology of the present disclosure may be applied;

FIG. 17 is a block diagram showing a second example of a schematic configuration of a base station to which the technology of the present disclosure may be applied;

FIG. 18 is a block diagram showing an example of a schematic configuration of a smartphone to which the technology of the present disclosure may be applied.

FIG. 19 is a block diagram showing an example of a schematic configuration of a vehicle navigation device to which the technology of the present disclosure may be applied.

Although the embodiments described in this disclosure may be susceptible to various modifications and alternatives, specific embodiments thereof are illustrated by way of example in the accompanying drawings and are described in detail herein. It should be understood, however, that the drawings and detailed description thereof are not intended to limit the embodiments to the particular forms disclosed; instead, it is intended to cover all modifications, equivalents and alternative falling within the spirit and scope of the claims.

### DETAILED DESCRIPTION

Representative applications of various aspects of the device and method according to the present disclosure are described below. These descriptions of these examples are merely to add a context and to aid in understanding the described embodiments. Therefore, it will be apparent to those skilled in the art that the embodiments described below may be practiced without some or all of the specific details. In other instances, well-known process steps have not been described in detail to avoid unnecessarily obscuring the described embodiments. Other applications are also possible, and the solution of the present disclosure is not limited to these examples.

Typically, a wireless communication system includes at least a network device and user equipments, and the network device may provide communication services for one or more user equipments.

In the present disclosure, the term “network device” (or “base station”) has the full breadth of its ordinary meaning, and includes at least a wireless communication station that is part of a wireless communication system or a radio system to facilitate communication. As an example, the network device may be an eNB in the 4G communication standard, a gNB in the 5G communication standard, a remote radio head, a wireless access point, a drone control tower, or a communication apparatus that performs similar functions. In the present disclosure, “network device” and “base station” may be used interchangeably, or “network device” may be implemented as a part of “base station”. Hereinafter, the network device will be used as example to describe application examples in detail in conjunction with the accompanying drawings.

In the present disclosure, the term “user equipment (UE)” or “terminal device” has the full breadth of its ordinary meaning, and includes at least a terminal device that is part of a wireless communication system or a radio system to facilitate communication. As an example, the user equipment may be, for example, a terminal device such as a mobile phone, a laptop, a tablet, a vehicle-mounted communication device, a wearable device, a sensor or the like, or an element thereof. In the present disclosure, “user equipment” (hereinafter may be referred to as “UE” for short) and “terminal device” may be used interchangeably, or “user equipment” may be implemented as a part of “terminal device”.

In the present disclosure, the terms “network device side”/“base station side” have the full breadth of their ordinary meaning, generally indicating a side of a communication system that transmits data in a downlink, or a side of a communication system that receives data in an uplink. Similarly, the terms “user equipment side”/“terminal device side” have the full breadth of their ordinary meaning, and accordingly may indicate a side of a communication system that receives data in a downlink, or a side of a communication system that transmits data in an uplink.

It should be noted that, although the embodiments of the present disclosure are mainly described below based on a communication system including a network device and user equipments, these descriptions may be accordingly extended to a case where a communication system includes any other type of network device side and user equipment side. For example, operations on the network device side may correspond to operations of a base station, while operations on the user equipment side may accordingly correspond to operations of a terminal device.

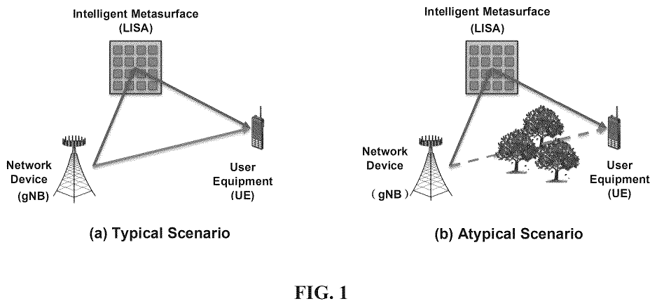

FIG. 1 illustrates an application scenario diagram of an intelligent metasurface. As described above, an intelligent metasurface may be composed of a large number of micro-reflective elements, each of which may independently adjust changes in amplitude and/or phase of a signal, thereby accurately controlling formation of a reflected beam. Generally speaking, an intelligent metasurface may be a two-dimensional plane for forming a three-dimensional reflected beam. It should be understood that examples of the intelligent metasurface include large intelligent surface antennas (LISA), reconfigurable intelligent surfaces (RIS), or other intelligent surfaces with similar structures and functions.

Application scenarios of the intelligent metasurface may be classified as typical scenarios and atypical scenarios. As shown in FIG. 1(a), in a typical application scenario, there is a Line-of-Sight (LOS) link connection between a network device (such as gNB) and a user equipment (UE), which may also be connected by a reflection link via an intelligent metasurface (such as LISA). As shown in FIG. 1(b), in an atypical application scenario, there is no LOS link connection between a network device and a user equipment due to occlusion or the like, and they need to be connected by a reflection link via an intelligent metasurface.

Intelligent metasurfaces may include two types: passive and active. Reflection units of a passive intelligent metasurface do not have an effect of amplifying an incident signal, while reflection units of an active intelligent metasurface have the effect of amplifying an incident signal. Studies have shown that in the typical application scenarios, since the received signal strength of an LOS link connection is much higher than that of a reflection link, an effect of improving overall channel capacity by using a passive intelligent metasurface is limited. However, in the atypical application scenarios, since the LOS link is blocked, the reflection link connection turns out to be a primary connection, about 65% gain in channel capacity may be brought by using a passive intelligent metasurface, which is a very obvious effect. In the case of using an active intelligent metasurface, the channel capacity gain in a typical application scenario may reach 129%, and the channel capacity gain in an atypical application scenario may even reach 1325%.

Since non-terrestrial network communications (for example, satellite communications) usually use high-frequency band communications (for example, millimeter waveband communications), obstruction by large obstacles such as high buildings and mountains may affect communication quality of a non-terrestrial network. In this regard, coverage and service area of the non-terrestrial network may be expanded by deploying intelligent metasurfaces to provide reflective links.

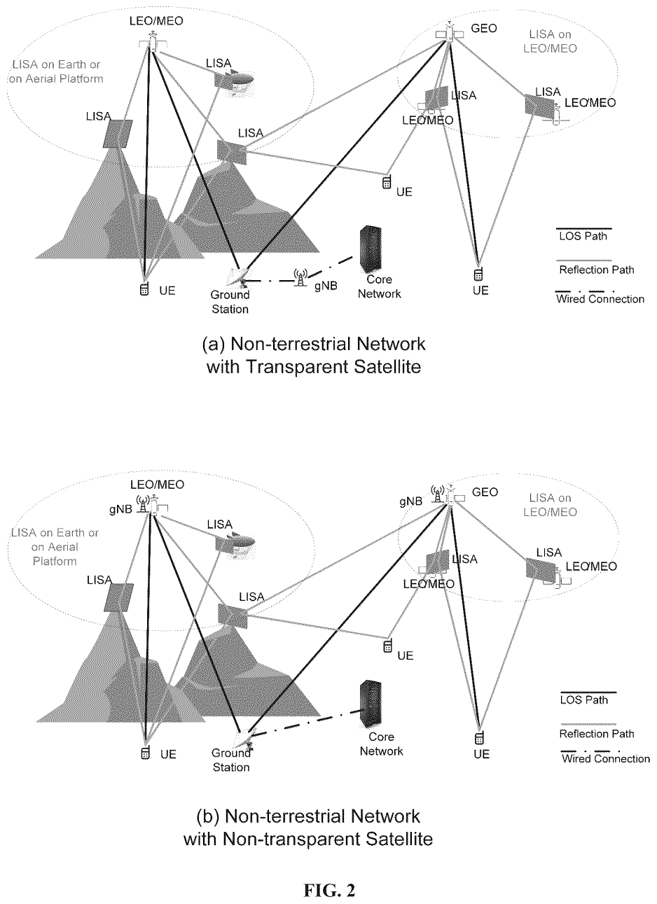

FIG. 2 illustrates an example scenario diagram of a non-terrestrial network using intelligent metasurfaces according to an embodiment of the present disclosure. It should be understood that FIG. 2 only illustrates an example of the non-terrestrial communication system, whose specific implementation may have more types and possible arrangements. For example, an actual non-terrestrial communication system may have more or fewer types of devices or larger or smaller numbers of devices. Features of the present disclosure may be implemented in any of various systems as needed.

According to an embodiment of the present disclosure, a non-terrestrial network may include a network device (such as gNB), a user equipment (UE), a satellite (such as a high orbit satellite (GEO), a medium orbit satellite (MEO), or a low orbit satellite (LEO)), and an intelligent metasurface (such as LISA, RIS). These devices may be configured to communicate via wireless transmission media. Generally speaking, non-terrestrial networks may be classified as non-terrestrial networks using a transparent satellite and non-terrestrial networks using a non-transparent satellite. As shown in FIG. 2(a), in a non-terrestrial network with a transparent satellite, the network device is located on the ground, and the satellite may forward signals from the network device to a user equipment or forward signals from the user equipment to the network device; as shown in FIG. 2(b), in a non-terrestrial network with a non-transparent satellite, the network device is located on the satellite and may communicate with a user equipment from the satellite.

On the one hand, satellite communications cannot guarantee to provide full coverage of communication service for user equipments on the ground. The satellite communications often use high-frequency band communications such as millimeter waveband communication. Obstacles such as high buildings and mountains block some user equipments on the ground, which destroys visible links between these user equipments and the satellite, and make the connection quality unable to meet requirements of normal communication (for example, similar to the atypical scenario shown in FIG. (1)b). In this regard, a plurality of intelligent reflective surfaces may be deployed to enable increase of the communication area covered by the non-terrestrial network by using reflective links. On the other hand, in a case that low-orbit satellites (LEOs) or medium-orbit satellites (GEOs) are used in a non-terrestrial network, these satellites move quickly relative to the ground, so that their projections on the ground will also move quickly (the speed may be close to 10 km/s). Thus, when a diameter of the ground projection of one satellite is, for example, about 100 kilometers, coverage duration of the satellite for a user equipment is only a few seconds. In this regard, the serving duration of the satellite when the satellite goes far away from the user equipment may be extended by using intelligent metasurfaces to increase reflective links. Generally speaking, deployed intelligent metasurfaces need to be used between the satellite and the user equipments to increase service coverage and extend service duration, regardless of the type of non-terrestrial network.

Unlike traditional terrestrial cellular networks, in the non-terrestrial network, satellites are far away from the ground, usually ranging from hundreds of kilometers to tens of thousands of kilometers. In this case, a plurality of intelligent metasurfaces may be deployed at locations far away from user equipments, for example, at the top of a number of high mountains, on aerial platforms, aircrafts, or even low-orbit satellites. A distance between the intelligent metasurface and the user equipment may be several kilometers, tens of kilometers, or even hundreds of kilometers. For a user equipment, there may be a plurality of intelligent metasurfaces covering it, and a distance between different intelligent metasurfaces may reach tens of kilometers or even hundreds of kilometers. Since path loss of a link is inversely proportional to square of a length of the link, distances of reflection links of different intelligent metasurfaces vary greatly, and the resulting path losses also vary greatly. In addition, at certain moments, deployment locations of some intelligent metasurfaces may be in a direction where the satellite is gradually moving away, and deployment locations of other intelligent metasurfaces may be in a direction where the satellite is gradually approaching. Therefore, based on actual scenario of the non-terrestrial network, selecting an appropriate intelligent metasurface as a relay is crucial to achieving better communication quality between the user equipment and the network device (located on a satellite or forwarding signals via the satellite).

For the non-terrestrial network using intelligent metasurfaces shown in FIG. 2, the present invention provides a method for path selection in the non-terrestrial network. Via the selected path, a user equipment may communicate with a network device located on a satellite via an intelligent reflective surface (for example, in a non-transparent satellite system), or communicate with a network device located on the ground via an intelligent reflective surface and then by forwarding via a satellite (for example, in a transparent satellite system), thereby improving the reliability and accuracy of data transmission.

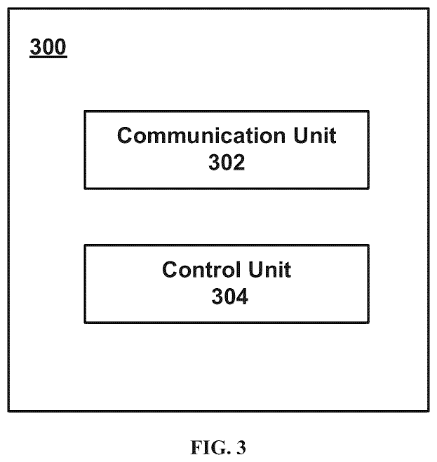

FIG. 3 illustrates an exemplary electronic device 300 for a user equipment in a non-terrestrial network according to an embodiment of the present disclosure. The electronic device 300 shown in FIG. 3 may include various units to implement various embodiments according to the present disclosure. In this example, the electronic device 300 includes a communication unit 302 and a control unit 304. In one implementation, the electronic device 300 is implemented as the user equipment itself or a part thereof, or is implemented as a device for controlling or otherwise related to the user equipment or a part of the device. Various operations described below in conjunction with the user equipment may be implemented by units 302, 304 or other possible units of the electronic device 300. It should be understood that the units 302 and 304 may be included or integrated in a processing circuit of the user equipment.

In an embodiment, the non-terrestrial network includes a user equipment, a network device that may communicate with the user equipment, a satellite, and a plurality of intelligent metasurfaces. The communication unit 302 may be configured to receive system relevant information of the non-terrestrial network from the network device. The system relevant information may include at least ephemeris information of the satellite, and identifiers and locations of one or more intelligent metasurfaces associated with the satellite among the plurality of intelligent metasurfaces. Optionally, in a case that the intelligent metasurfaces are active intelligent metasurfaces, the system relevant information may also include gains of one or more intelligent metasurfaces associated with the satellite. Thereafter, the control unit 304 may be configured to determine a path for the user equipment to communicate with the network device based at least on the received system relevant information. The determined path goes through one of the one or more intelligent metasurfaces. Via the determined path, the communication unit 302 may be configured to communicate with the network device.

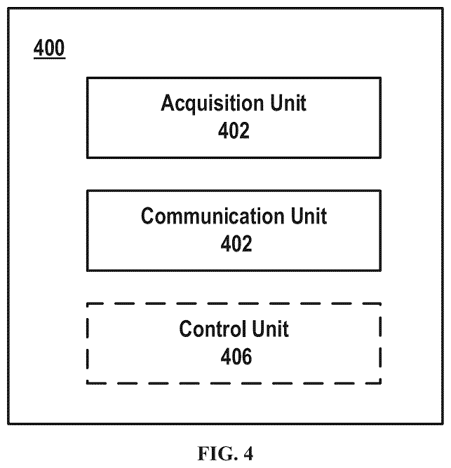

FIG. 4 illustrates an exemplary electronic device 400 for a network device in a non-terrestrial network according to an embodiment of the present disclosure. The electronic device 400 shown in FIG. 4 may include various units to implement various embodiments according to the present disclosure. In this example, the electronic device 400 includes an acquisition unit 402, a communication unit 404, and optionally a control unit 406. In one implementation, the electronic device 400 is implemented as the network device itself or a part thereof, or is implemented as a device related to the network device or a part of the device. Various operations described below in conjunction with the network device may be implemented by units 402, 404, 406 or other possible units of the electronic device 400. It should be understood that the units 402, 404 and 406 may be included or integrated in a processing circuit of the network device.

In an embodiment, the non-terrestrial network includes a network device, a user equipment that may communicate with the network device, a satellite, and a plurality of intelligent metasurfaces. The acquisition unit 402 may be configured to acquire system relevant information of the non-terrestrial network. The system relevant information may include at least ephemeris information of the satellite, and identifiers and locations of one or more intelligent metasurfaces associated with the satellite among the plurality of intelligent metasurfaces. The one or more intelligent metasurfaces may be determined by the network device (for example, by the control unit 406) based at least on a location of the satellite and the locations of the plurality of intelligent metasurfaces. Optionally, in a case that the intelligent metasurfaces are active intelligent metasurfaces, the system relevant information may also include gains of one or more intelligent metasurfaces associated with the satellite. Thereafter, the communication unit 404 may be configured to communicate with the user equipment via a determined path. The path is determined based at least on the system relevant information, and the determined path goes through one of the one or more intelligent metasurfaces. It should be understood that the path may be determined by the user equipment with its control unit 304, or by the network device with its control unit 406.

In some embodiments, the electronic devices 300 and 400 may be implemented at the level of a chip, or may also be implemented at the level of a device by including other external components (e.g., radio links, antennas, etc.) For example, each electronic device may function as a communication device as a whole.

It should be noted that above units are only logical modules divided according to specific functions they implement, and are not used to limit specific implementations, for example, they may be implemented in software, hardware, or a combination of software and hardware. In practical implementations, above units may be implemented as independent physical entities, or may also be implemented by a single entity (e.g., a processor (CPU or DSP, etc.), an integrated circuit, etc.). Wherein, the processing circuit may refer to various implementations of digital circuitry, analog circuitry, or mixed-signal (combination of analog and digital) circuitry that perform functions in a computing system. The processing circuits may include, for example, circuits such as Integrated Circuits (ICs), Application Specific Integrated Circuits (ASICs), portions or circuits of individual processor cores, entire processor cores, individual processors, programmable hardware devices such as Field Programmable Gate Arrays (FPGAs), and/or systems including multiple processors.

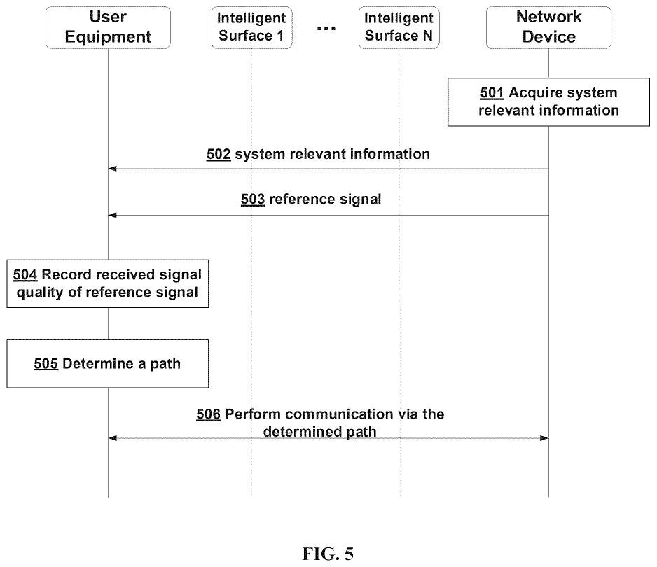

The schematic configurations of a user equipment and a network device according to the embodiments of the present disclosure have been described above in conjunction with the accompanying drawings. An information interaction diagram for path selection in a non-terrestrial network using intelligent metasurfaces according to an embodiment of the present disclosure will be described below with reference to FIG. 5. The non-terrestrial network includes a user equipment, a network device, a satellite, and a plurality of intelligent metasurfaces. The user equipment may communicate with a network device located on the satellite via an intelligent metasurface (for example, a non-transparent satellite system), or may communicate with a network device located on the ground via an intelligent metasurface and then via satellite forwarding (for example, a transparent satellite system).

It should be understood that although gain improvement provided by an intelligent metasurface is limited when there is a visible link connection between a user equipment and a satellite in a non-terrestrial network, the present disclosure is intended to solve the problems of poor service quality or short service duration provided to users due to obstruction by high buildings between the satellite and the user equipment or too fast satellite movement speed. Therefore, the embodiments of the present disclosure focus on discussing providing improved communication service quality of the non-terrestrial network with aid of a reflection link of an intelligent metasurface. In other words, in a practical application, if it is detected that there is a visible link connection with good communication quality between the user equipment and the satellite in the non-terrestrial network, the link may be used directly for communication; if it is detected that there is no visible link connection between the user equipment and the satellite in the non-terrestrial network or the service quality provided by the visible link connection is poor, the method of providing a reflection link using an intelligent metasurface as proposed in the present disclosure may be combined to select a path g through an appropriate intelligent metasurface for communication. It should also be understood that whether a transparent satellite system or a non-transparent satellite system, it is necessary to find an appropriate intelligent metasurface between the satellite and the user equipment as a relay to improve the quality of communication service of the non-terrestrial network.

As shown in FIG. 5, at 501, the network device acquires system relevant information of the non-terrestrial network. According to an embodiment of the present disclosure, the system relevant information may include at least ephemeris information of the satellite, and identifiers and locations of one or more intelligent metasurfaces associated with the satellite among the plurality of intelligent metasurfaces. The ephemeris information of the satellite generally includes, for example, a location of the satellite, a number of the satellite, movement trajectory information of the satellite (including moving speed and moving direction of the satellite), and the like. It should be understood that one or more intelligent metasurfaces associated with the satellite (as shown in FIG. 5, numbered as intelligent metasurface 1, . . . , intelligent metasurface N, where N is an integer greater than or equal to 1) may be selected and determined by the network device based on the location of the satellite (for example, the location may be derived from the ephemeris information of the satellite) and the locations of the plurality of intelligent metasurfaces. For example, it is almost impossible for an intelligent metasurface far away from the satellite and in a direction where the satellite is gradually moving away to provide an improved gain for the communication of the non-terrestrial network, so the network device is likely not to select the intelligent metasurface as a candidate relay, thereby not sending its information (included in the system relevant information) to the user equipment. In addition, the one or more intelligent metasurfaces associated with the satellite may change over time. It should also be understood that when the intelligent metasurfaces are active intelligent metasurfaces, the system relevant information may also include gains of the above one or more intelligent metasurfaces. In a case that an intelligent metasurface is in a stationary installation, the intelligent metasurface may report its geographic location, gain and other information to the network device in advance. In a case that an intelligent metasurface is installed on a moving object (for example, an aircraft, an aerial platform, an LEO/MEO satellite), the intelligent metasurface may periodically or non-periodically report its geographic location, gain, corresponding timestamp and other information to the network device. Optionally, a timer may also be used to control the time when the intelligent metasurface reports its own information as described above, that is, when the timer expires, the intelligent metasurface may report its own information to the network device. Accordingly, the network device may periodically or non-periodically update the system relevant information of the non-terrestrial network. For example, the network device may set an update period of the system relevant information based on the moving speed of the satellite, wherein the update period is set to be short when the satellite moving speed is fast, and the update period is set to be long when the satellite moving speed is slow.

At 502, the network device may send the system relevant information of the non-terrestrial network to the user equipment. At 503, the network device may transmit reference signals to the user equipment. Specifically, the network device may transmit the reference signals to the user equipment via each of a plurality of paths (each path going through one intelligent metasurface) going through a part or all of the above one or more intelligent metasurfaces (for example, intelligent metasurface 1—intelligent metasurface N), respectively. Correspondingly, at 504, the user equipment may record a received signal quality of the reference signal corresponding to each path in the plurality of paths.

It should be understood that, according to an embodiment of the present disclosure, the network device side may use an antenna array including a plurality of antenna elements to form a directional beam, thereby improving transmission efficiency and system throughput. The user equipment side may use a single antenna or an antenna array including a plurality of antenna elements. It should also be understood that, according to an embodiment of the present disclosure, examples of the reference signal include synchronization signal block (SSB), channel state information reference signal (CSI-RS), and other reference signal sent by the network device as known to those skilled in the art. According to an embodiment of the present disclosure, the received signal quality includes, but is not limited to, reference signal received power (RSRP), reference signal received quality (RSRQ), signal to interference and noise ratio (SINR), or the like.

Next, at 505, the user equipment may determine a path for the user equipment to communicate with the network device based at least on the received system relevant information, wherein the determined path goes through one of the one or more intelligent metasurfaces. More specifically, the user equipment may select one path from the plurality of paths as the determined path based at least on the system relevant information and the received signal quality corresponding to each of the plurality of paths recorded at 504. It should be understood that the determined path may be the same as or different from the path through which the user equipment to receive the reference signal with the highest received signal quality at 503. In other words, the user equipment does not necessarily select the best path in terms of the current measurements directly (i.e., the path with the highest received signal quality), but may comprehensively judge and select a path that will behave well in subsequent non-terrestrial communications in combination with the system relevant information. As an example, when a difference between a received signal quality corresponding to one path of the plurality of paths and the highest received signal quality is less than a first threshold, and a duration when the intelligent metasurface in this path is covered by the satellite is greater than a duration when the intelligent metasurface in the path with the highest received signal quality is covered by the satellite and is greater than a second threshold, then the user equipment may select this path as the determined path. It should be understood that the durations when the intelligent metasurfaces are covered by the satellite may be derived from the system relevant information. It should be appreciated that the first threshold and the second threshold may be numerical values that are preset, or calculated according to priori measurement information.

At 506, the user equipment may communicate with the network device via the determined path. It should be understood by those skilled in the art that since both the satellite and the intelligent metasurface may move, and the user equipment may also move, the determined intelligent metasurface path may not maintain a good communication quality after a period of time. In this regard, the network device may set a specific time window and inform the user equipment of the time window, or the user equipment may determine the time window based on information provided by the network device. After the time window expires, the steps in FIG. 5 may be repeated so as to reacquire the system relevant information and perform the path selection. It should be understood that the value of the time window may be a fixed value (for example, the path selection is updated periodically) or a variable value (for example, the path selection is updated non-periodically).

It should be noted that the information interaction diagram shown in FIG. 5 is merely an example and is not intended to be limiting. The diagram may include more or fewer steps, and the steps may also be performed in an order different from that of the steps depicted in the diagram.

In one example, when the plurality of intelligent metasurfaces are statically deployed and the satellite is a synchronous satellite, the system relevant information of the non-terrestrial network may be pre-stored in the user equipment directly, so the step of sending the system relevant information by the network device to the user equipment at 502 may be omitted. In another example, the orders of 502 and 503 may be interchanged. For example, the network device may send the system relevant information after transmitting a plurality of reference signals to the user equipment. In yet another example, between 505 and 506, the user equipment may report the determined path to the network device, for example, report an identifier of the intelligent metasurface in the determined path to the network device. Wherein, the identifier of the intelligent metasurface may be sent to the user equipment by the intelligent metasurface when forwarding the reference signal (by means of information scrambling or the like); or the user equipment may derive the identifier of the intelligent metasurface through which the reference signal passes according to the angle of arrival antenna of the received reference signal, in combination with its own location and the location of the satellite in the system relevant information (the location of the satellite may be included in the ephemeris information of the satellite) and the identifiers and locations of one or more intelligent metasurfaces.

It should be appreciated that the steps of transmitting reference signals and recording the received signal quality of the reference signals may also be omitted in FIG. 5. According to the system relevant information, the user equipment (or the network device) may calculate and derive a preferred communication path based on the locations of the satellite and of one or more intelligent metasurfaces (and optionally, of the user equipment) and the movement information of the satellite. This process may be applicable to a scenario such as emergency recovery after communication interruption, or the like.

It should be understood that, the step of determining a path in FIG. 5 may also be performed by the network device. Accordingly, the step of transmitting the system relevant information by the network device to the user equipment at 502 may be omitted, and a step of the user equipment reporting the received signal quality of the reference signal corresponding to each path in the plurality of paths to the network device may be added between 504 and 505, for the network device to select one path from the plurality of paths as the determined path based on the system relevant information and the reported received signal quality.

According to an embodiment of the present disclosure, the method for path selection in a non-terrestrial network using intelligent metasurfaces proposed herein may be adopted in a variety of scenarios. The intelligent metasurface path selection method in three scenarios will be introduced and described in detail below through three embodiments (including a first embodiment, a second embodiment and a third embodiment).

### First Embodiment: Intelligent Metasurface Path Selection Before a User Equipment Accesses a Network

In the first embodiment, the user equipment has not yet accessed a non-terrestrial cellular network system, and has not yet requested time and frequency resources for uplink and downlink after accessing the network. Therefore, the network device and the user equipment cannot exchange information at predetermined time and frequency. The network device and the user equipment may not even know geographical location of each other.

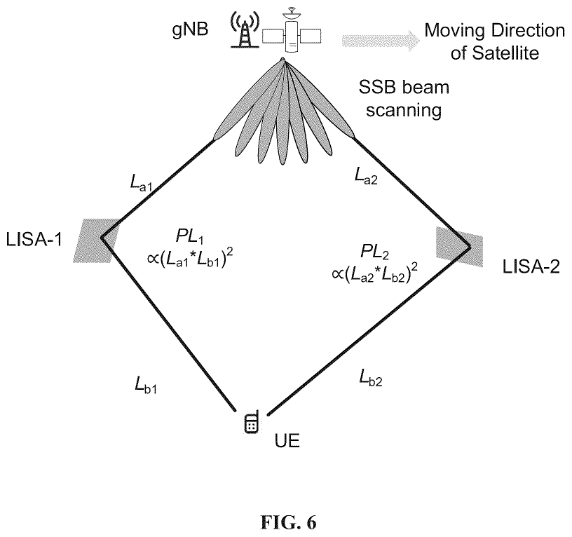

FIG. 6 illustrates a schematic diagram according to the first embodiment of the present disclosure. For ease of explanation, FIG. 6 illustrates an example of only two intelligent metasurfaces (for example, LISA-1 and LISA-2), and in an actual non-terrestrial network, more or less intelligent metasurfaces may be included. It should be understood that, although FIG. 6 illustrates only an example of a non-transparent satellite system, the path selection method in the first embodiment is also applicable to a transparent satellite system in which signals are forwarded to a network device (for example, gNB) through a satellite.

As shown in FIG. 6, the network device may continuously transmit synchronization signal blocks (SSBs) at a certain time interval, that is, perform SSB beam scanning, in which the network device transmits one SSB signal in each of multiple beam directions. The user equipment selects the SSB signal in the optimal SSB direction (for example, the direction corresponding to the SSB signal with the best received signal quality) to achieve downlink synchronization. In general, the received signal quality of the reference signal is related to a path loss of the signal, and the path loss PL is proportional to a product of the squares of the distances of the two reflection links (for example, Lₐ and L_{b}) passing through the intelligent reflective surface. Therefore, the longer the distance is, the greater the spatial loss of the link is (in addition, if the intelligent metasurface is an active intelligent metasurface, the gain also needs to be considered).

The SSB signal includes a primary synchronization signal (PSS) and a secondary synchronization signal (SSS). Therefore, by receiving the SSB signal, the user equipment may obtain system information of a cell number (PCI) and a frame start bit and a physical broadcast channel (PBCH), and then obtain a system information block SIB1 message of the system. The SIB1 message includes a time-frequency scheduled transmission message for a subsequent system information block SIBx (for example, x=2 . . . 21). After the user equipment decodes the SIB1, it may acquire respective SIBx information on the scheduled time-frequency resource. The network device may include system relevant information of the non-terrestrial network in the system information block SIBx and send it to the user equipment for subsequent path selection by the user equipment.

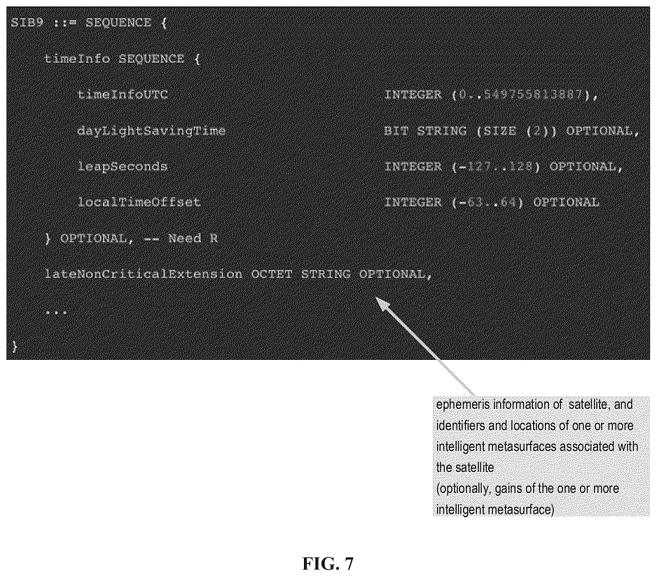

According to some embodiments of the present disclosure, the existing system information block SIBx (for example, x=2 . . . 21) may be extended to include the system relevant information of the non-terrestrial network. As described above, the system relevant information may include ephemeris information of a satellite, and identifiers and locations of one or more intelligent metasurfaces (and optionally, gains of the one or more intelligent metasurfaces) associated with the satellite (the one or more intelligent metasurfaces may be determined by the network device based at least on locations of the satellite and a plurality of intelligent metasurfaces in the non-terrestrial network). FIG. 7 illustrates a code segment of an existing SIB9 message, which includes the global positioning system (GPS) time and the international coordinated time (UTC) therein. According to the present disclosure, the existing SIB9 message may be extended to carry the system relevant information such as ephemeris information of a satellite and identifiers and locations of intelligent metasurfaces. Additionally or alternatively, a new system information block SIBx (for example, x=22 . . . ) may be defined to carry the system relevant information of the non-terrestrial network.

After receiving the system information block SIBx including the system relevant information, the user equipment may determine which intelligent metasurface's path should be selected for random access based on the recorded SSB received signal quality and the system relevant information. Generally speaking, the SSB signal in each direction corresponds to one separate access time-frequency resource. Therefore, according to the access time-frequency resource of the SSB signal in respective direction of the determined path, the user equipment may transmit a random access preamble on the access time-frequency resource via the determined path, thereby accessing the non-terrestrial network and communicating with the network device.

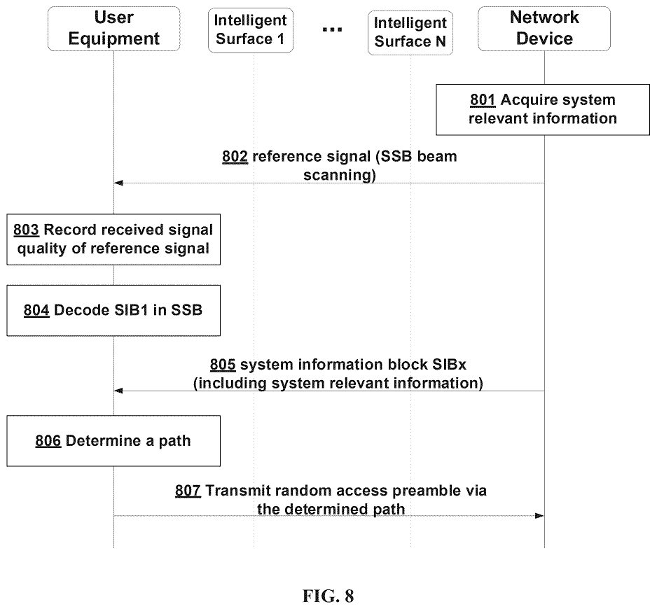

FIG. 8 illustrates an information interaction diagram of the first embodiment for path selection in a non-terrestrial network using intelligent metasurfaces according to the present disclosure. As shown in FIG. 8, at 801, a network device acquires system relevant information of a non-terrestrial network, which may include ephemeris information of a satellite, and identifiers and locations of one or more intelligent metasurfaces associated with the satellite (and optionally, gains of one or more intelligent metasurfaces). As shown in FIG. 8, one or more intelligent metasurfaces are numbered as intelligent metasurface 1, . . . , intelligent metasurface N, where N is an integer greater than or equal to 1. As an example, N corresponding to FIG. 6 is equal to 2. At 802, the network device broadcasts SSB signals in multiple directions to a user equipment, i.e., performs SSB beam scanning. It should be understood that directions of the SSBs are predetermined in advance, there may not be an intelligent metasurface in the direction of each SSB, and the SSB beam scanning process may not necessarily traverse all of the intelligent metasurfaces of one or more intelligent metasurfaces. Correspondingly, the user equipment may receive the SSB signals via part or all of the intelligent metasurfaces, and record the received signal quality of the SSB signals at 803, and then receive SIB1 signal in the direction of the SSB signal with the strongest received signal quality. At 804, the user equipment may decode the SIB1 signal to obtain time-frequency resource scheduling information of its subsequent system information block SIBx message. According to an embodiment of the present disclosure, the existing SIBx (for example, SIB9) message may be extended or a new SIBx message may be defined to carry the system relevant information. Correspondingly, at 805, the user equipment may receive a system information block message including the system relevant information from the network device. Furthermore, the user equipment may determine a path for accessing the non-terrestrial network based at least on the system relevant information at 806. Specifically, the user equipment may determine which intelligent metasurface the path goes through for transmitting a random access preamble based on the received signal quality of the SSB signal in combination with the system relevant information.

At 807, the user equipment may transmit a random access preamble to the network device via the determined path on the time-frequency resource corresponding to the SSB signal in the direction of the path, so as to access the non-terrestrial network. It should be appreciated that, after the user equipment accesses the non-terrestrial network, the user equipment may be instructed to perform, preferentially with the beam directed toward the intelligent metasurface in the determined path, multiple subsequent operations such as but not limited to one or more of beam scanning, data reception, beam recovery, etc.

It should be understood that details of some operations in FIG. 8 have been described in detail in FIG. 5 and will not be repeated here.

Referring back to FIG. 6, for example, assuming that there is an obstruction between the satellite and the user equipment, the signal quality of the SSB received by the user equipment via LISA-1 and LISA-2 is better. Since the path loss is related to distance lengths of two reflection links (when using a passive intelligent metasurface), the loss on the path for transmitting the SSB via LISA-1 is smaller, so the user equipment may receive the SIB1 signal in the direction of this SSB signal (i.e., the aforementioned optimal SSB direction), and receive subsequent SIBx message (for example, an extended SIB9 message) including the system relevant information according to the time-frequency resource scheduling information in SIB1. According to the acquired system relevant information, the user equipment may know that although the quality of the received signal on the LISA-1 path (i.e., the path via LISA-1) is slightly better than that on the LISA-2 path (i.e., the path via LISA-2), the moving direction of the satellite is going away from LISA-1 and approaching to LISA-2, that is, the signal transmitted on the LISA-2 path will have a longer duration of satellite coverage. For example, when the difference in the received signal quality of the above two paths is within a certain range (for example, an absolute value of the difference is less than a first threshold) and the duration of satellite coverage of the LISA-2 path is longer than that of the LISA-1 path and is greater than a certain threshold (for example, a second threshold), the LISA-2 path with higher comprehensive communication quality may be selected for accessing the non-terrestrial network, thereby improving the access success rate.

Additionally or alternatively, in addition to the system information block, the system relevant information may also be included in another signal that can be contemplated by those skilled in the art for transmission to the user equipment. In addition, the system relevant information may also be transmitted from the network device to the user equipment through another wireless communication system.

### Second Embodiment: Intelligent Metasurface Path Selection After a User Equipment Accesses a Network

In the second embodiment, the user equipment has accessed the non-terrestrial cellular network system and may perform bidirectional information exchange with a network device. In some examples, the user equipment may notify the network device of its geographical location.

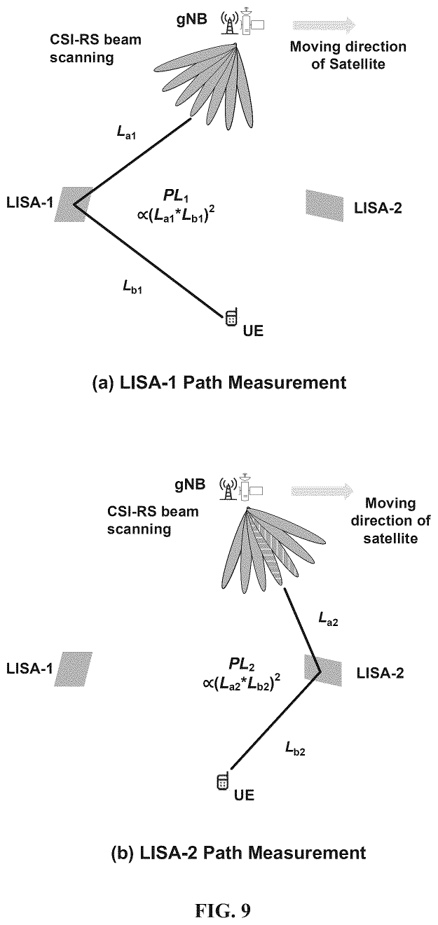

FIG. 9 illustrates a schematic diagram according to the second embodiment of the present disclosure. Similar to FIG. 6, for ease of explanation, FIG. 9 only illustrates an example of two intelligent metasurfaces (for example, LISA-1 and LISA-2), and in an actual non-terrestrial network, more or less intelligent metasurfaces may be included. It should be understood that, although FIG. 9 illustrates only an example of a non-transparent satellite system, the path selection method in the second embodiment is also applicable to a transparent satellite system in which signals are forwarded to a network device (for example, gNB) through a satellite.

As shown in FIG. 9, the network device may perform beam scanning (for example, CSI-RS beam scanning) in a direction of each of intelligent metasurfaces, that is, transmit multiple CSI-RS beams. Each intelligent metasurface may reflect a number of beams toward the user equipment for measuring a received signal quality of a path going through the intelligent metasurface. It should be understood that a time-frequency resource for beam measurement for each intelligent metasurface (for example, through beam scanning predetermined information) may pre-allocated by the network device and informed to the user equipment. In this way, the user equipment may measure the received beam accordingly in accordance with the predetermined time-frequency resource and record measurements of the received signal quality.

Specifically, as shown in FIG. 9(a), the network device has acquired location information of one or more intelligent metasurfaces (for example, LISA-1 and LISA-2) associated with the satellite, and sequentially transmits the CSI-RS beams in multiple small directions subdivided in the direction of LISA-1 at a predetermined first time. LISA-1 reflects these beams toward the user equipment sequentially, so that the user equipment receives the beams in the small directions and measures their received signal quality. Similarly, as shown in FIG. 9(b), the network device sequentially transmits the CSI-RS beams in multiple small directions subdivided in the direction of LISA-2 at a predetermined second time. LISA-2 reflects these beams toward the user equipment sequentially, so that the user equipment receives the beams in the small directions and measures their received signal quality. It should be understood that in this embodiment, since the network device has knowledge of the locations of individual intelligent metasurfaces, the measured paths may traverse all of the one or more intelligent metasurfaces associated with the satellite. It should also be understood that, for each intelligent metasurface, since the network device may transmit reference signals to the user equipment via the intelligent metasurface in multiple small directions, it may be considered that the network device can transmit the reference signals to the user equipment via multiple paths through the intelligent metasurface.

In general, the received signal quality of the reference signal is related to a path loss of the signal, and the path loss PL is proportional to a product of the squares of the distances of the two reflection links (for example, Lₐ and L_{b}) going through the intelligent reflective surface. Therefore, the longer the distance is, the greater the spatial loss of the link is (in addition, if the intelligent metasurface is an active intelligent metasurface, the gain also needs to be considered).

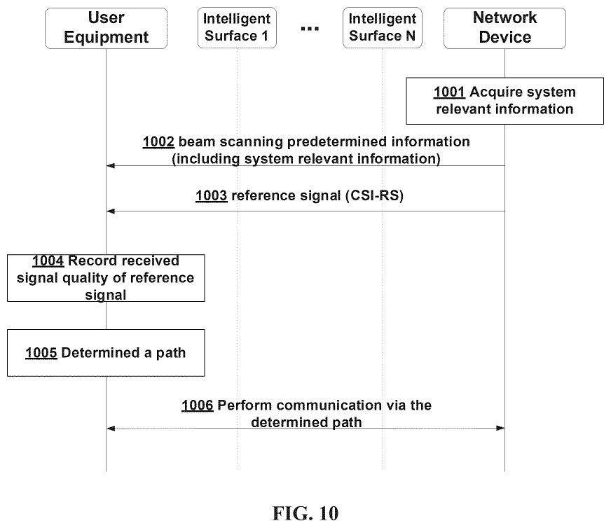

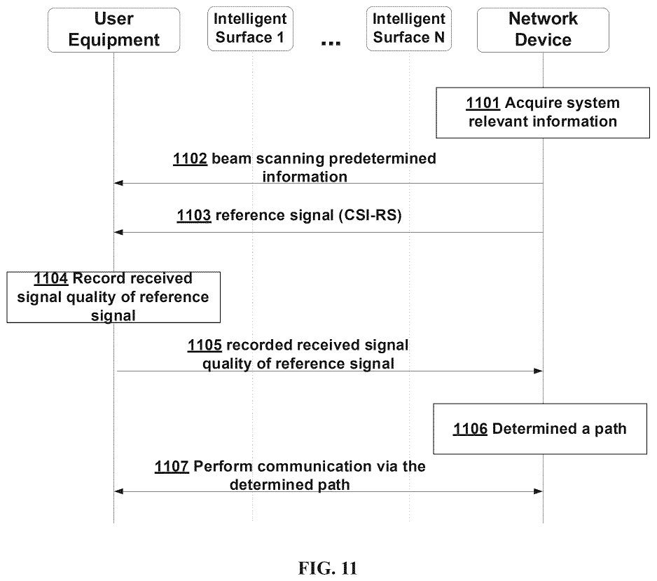

According to the second embodiment of the present disclosure, after the user equipment performs the measurement of the reference signal, a final communication path may be determined in two ways. One way is that the user equipment determines the path, and the other way is that the network device determines the path. FIGS. 10 and 11 illustrate information interaction diagrams under these two ways, respectively.

FIG. 10 illustrates an information interaction diagram for determining a path by the user equipment. As shown in FIG. 10, at 1001, the network device acquires system relevant information of the non-terrestrial network, which may include ephemeris information of a satellite, and identifiers and locations of one or more intelligent metasurfaces (and optionally, gains of the one or more intelligent metasurfaces) associated with the satellite (the one or more intelligent metasurfaces may be determined by the network device based at least on the locations of the satellite and a plurality of intelligent metasurfaces in the non-terrestrial network (and optionally, the location of a user equipment)). As shown in FIG. 10, one or more intelligent metasurfaces are numbered as intelligent metasurface 1, . . . , intelligent metasurface N, where N is an integer greater than or equal to 1. As an example, N corresponding to FIG. 9 is equal to 2. Before the network device performs beam scanning, the network device may send the system relevant information to the user equipment at 1002. As an example, the system relevant information may be carried and transmitted in beam scanning predetermined information, which also specifies time-frequency resources for subsequent transmissions of reference signal (for example, CSI-RS). Correspondingly, at 1003, the network device performs CSI-RS beam scanning on respective time-frequency resources to the user equipment, wherein the network device may transmit reference signals in multiple subdivided directions in the direction of each intelligent metasurface. The user equipment may record a received signal quality of the reference signal via each of the paths at 1004, and may determine a path for communication based on the system relevant information and the recorded received signal quality of the CSI-RS at 1005. At 1006, the user equipment may communicate with the network device via the determined path (using a beam direction corresponding to the path). Additionally, the user equipment may also report the determined path to the network device (for example, reporting an identifier of an intelligent metasurface through which the path passes and the corresponding CSI-RS beam number to the network device) so that the network device performs communication with the user equipment via the determined path.

Additionally or alternatively, besides the beam scanning predetermined information, the system relevant information may also be included in another signal that may be contemplated by those skilled in the art for transmission to the user equipment. In addition, the system relevant information may also be transmitted from the network device to the user equipment by another wireless communication system.

FIG. 11 illustrates an information interaction diagram for determining a path by the network device. As shown in FIG. 11, as shown in FIG. 11, at 1101, the network device acquires system relevant information of the non-terrestrial network, which may include ephemeris information of a satellite, and identifiers and locations of one or more intelligent metasurfaces (and optionally, gains of the one or more intelligent metasurfaces) associated with the satellite (the one or more intelligent metasurfaces may be determined by the network device based at least on the locations of the satellite and a plurality of intelligent metasurfaces in the non-terrestrial network (and optionally, the location of a user equipment)). As shown in FIG. 11, one or more intelligent metasurfaces are numbered as intelligent metasurface 1, . . . , intelligent metasurface N, where N is an integer greater than or equal to 1. As an example, N corresponding to FIG. 9 is equal to 2. Although the network device sends beam scanning predetermined information to the user equipment at 1102, the information only specifies time-frequency resources for subsequent transmissions of reference signal (for example, CSI-RS), and does not need to include the system relevant information. At 1103, the network device may perform CSI-RS beam scanning on respective time-frequency resources to the user equipment, wherein the network device may transmit reference signals in multiple subdivided directions in the direction of each intelligent metasurface. Accordingly, the user equipment may record a received signal quality of the reference signal via each of the paths at 1104. At 1105, the user equipment reports the recorded measurements (i.e., the received signal quality of the reference signal corresponding to individual paths) to the network device, so that the network device determines a path for communication based on the system relevant information and the received reported received signal quality of CSI-RS at 1106. At 1007, the network device may communicate with the user equipment via the determined path (using the beam direction corresponding to the path).

It should be understood that details of some operations in FIG. 10 and FIG. 11 have been described in detail in FIG. 5 and will not be repeated here.

Referring back to FIG. 9, for example, assuming that there is an obstruction between the satellite and the user equipment, the user equipment receives multiple CSI-RS signals via LISA-1 and LISA-2 respectively. Since the path loss is related to distance lengths of two reflection links (when using a passive intelligent metasurface), the loss on the path for transmitting the CSI-RS via LISA-2 is smaller. More specifically, the path loss in the direction of the 4th CSI-RS beam (as shown by cross striped beam in FIG. 9(b)) transmitted toward the direction of LISA-2 is the smallest, that is, the received signal quality measurement obtained through this path is the largest. In combination with the relevant information of the system, it may be known that the received signal quality on the LISA-2 path (that is, the path via LISA-2) is better than that on the LISA-1 path (that is, the path via LISA-1), and the moving direction of the satellite is going away from LISA-1 and approaching to LISA-2, that is, the signal transmitted on the LISA-2 path will have a longer duration of satellite coverage. Therefore, the path selected by the user equipment or the network device is reflected via LISA-2. More specifically, as shown in FIG. 9(b), there are multiple paths going through LISA-2. As an example, although the received signal quality corresponding to the path in the direction of the 4th CSI-RS beam transmitted toward the direction of LISA-2 is the largest, the difference in received signal quality between it and the path in the direction of the 5th CSI-RS beam (as shown by vertical striped beam in FIG. 9(b)) is less than a certain threshold (for example, a first threshold), and the duration when the latter path is covered by the satellite is longer and is greater than a certain threshold (for example, a second threshold), so the latter path (the path via LISA-2 corresponding to the vertical striped beam direction in FIG. 9(b)) through which subsequent communication will have higher comprehensive quality may be selected as the determined path for communication.

### Third embodiment: Intelligent Metasurface Path Selection for a User Equipment to Switch a Cell

In the third embodiment, the user equipment has accessed the non-terrestrial cellular network system, and due to reasons such as movement of the user equipment or a satellite, the user equipment needs to switch to another cell (for example, from communicating with an original gNB to communicating with a target gNB).

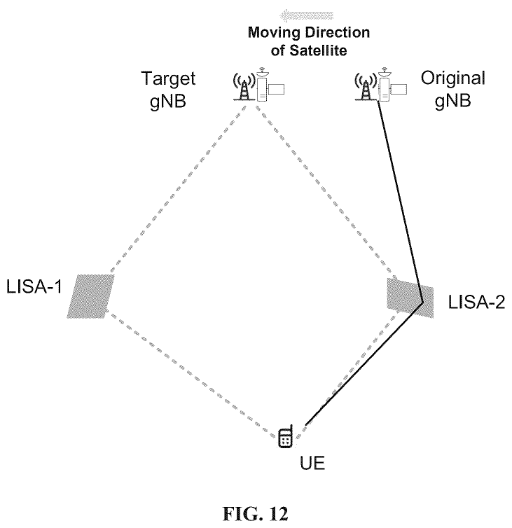

FIG. 12 illustrates a schematic diagram according to the second embodiment of the present disclosure. Similar to FIG. 6 and FIG. 9, for ease of explanation, FIG. 12 only illustrates an example of two intelligent metasurfaces (for example, LISA-1 and LISA-2), and in an actual non-terrestrial network, more or less intelligent metasurfaces may be included. It should be understood that, although FIG. 12 illustrates only an example of a non-transparent satellite system, the path selection method in the third embodiment is also applicable to a transparent satellite system in which signals are forwarded to the network device through a satellite.

Generally speaking, when a user equipment finds that the communication quality is poor even after switching the path, it may measure the received signal quality of neighboring cells and switch to a neighboring cell that may provide better communication quality after an appropriate condition is triggered. As shown in FIG. 12, in this example, the user equipment may communicate with an original gNB in original cell through a path via LISA-2 (which is the previous preferred path). Since LISA-1 is far away from the original gNB, the original gNB does not use LISA-1 as a candidate intelligent metasurface, so information about LISA-1 may not be provided in the system relevant information. Similarly, since LISA-2 is far away from a target gNB, the target gNB may not use LISA-2 as a candidate intelligent metasurface for user equipments in its cell, so information about LISA-2 may not be provided in the system relevant information. According to this embodiment, after the user equipment has switched to the cell where the target gNB is located, both LISA-1 and LISA-2 may be used as candidate intelligent metasurfaces to provide reflection links for improving the communication quality of the non-terrestrial network.

According to FIG. 12, after switching to the target gNB, the user equipment may send information of an intelligent metasurface (for example, LISA-2) in the preferred path previously determined in the original cell to the target gNB, which may include at least an identifier and location of LISA-2, and the like. Based at least on the information, the network device may select a switched path for communication, or instruct the user equipment to select a switched path. For the selection of the switched path, a method similar to that in the second embodiment may be performed.

It should be understood that each network device may determine one or more intelligent metasurfaces (sometimes referred to herein as one or more intelligent metasurfaces associated with a satellite) based at least on information such as locations of the satellite and a plurality of intelligent metasurfaces, and include the information of the one or more intelligent metasurfaces (as a candidate intelligent metasurface set) in the system relevant information for the path selection in the non-terrestrial network. Since different network devices are in different locations and environments, the candidate intelligent metasurface sets determined by them are also different. For example, in the switching process of the user equipment, an intelligent metasurface in a preferred path provided by the original gNB may be incorporated into the candidate intelligent metasurface set determined by the target gNB, thereby increasing the path selection range in the target cell and helping the target gNB to determine the switched path more quickly and accurately.

It should be appreciated that the specific example descriptions in the above embodiments (including the first embodiment, the second embodiment, and the third embodiment) are merely exemplary and are not intended to be limiting. In practice, there may be more user equipments and network devices. For each user equipment and each network device, the above methods provided in the present disclosure may be used to select a non-terrestrial network communication path in various examples. It is understandable that, in a case that the network device is a gNB and the gNB includes multiple transmit and receive points (TRPs), the above methods may be used to select and determine a non-terrestrial network communication path between each user equipment and each TRP.

### Technical Effects of the Present Disclosure

According to the method for path selection in a non-terrestrial network (NTN) using intelligent metasurfaces proposed in the present disclosure, a preferred path may be determined by a user equipment or a network device based at least on NTN system relevant information (for example, at least including ephemeris information of a satellite, and identifiers and locations of one or more intelligent metasurfaces associated with the satellite, etc.). The preferred path can provide a reflection link for NTN communication between the network device and the user equipment via an appropriate intelligent metasurface, thereby improving channel capacity gain in scenarios where the quality of visible link communication is poor.

Before a user equipment accesses an NTN cellular network, by extending existing or defining new messages (for example, SIB messages) to transmit NTN system relevant information, the user equipment may be facilitated to determine a preferred path for random access, which significantly improves a success rate of the access. After the user equipment has accessed the NTN cellular network, the network device or the user equipment determines a preferred path based at least on the system relevant information (and the reference signal measurement results), which may effectively improve the channel capacity and improve the overall transmission efficiency of the system. In a scenario that a user equipment performs cell switching, a target network device may determine a preferred switched path more quickly and accurately based on information such as an intelligent metasurface in an original preferred path provided by an original network device.

### Exemplary Methods

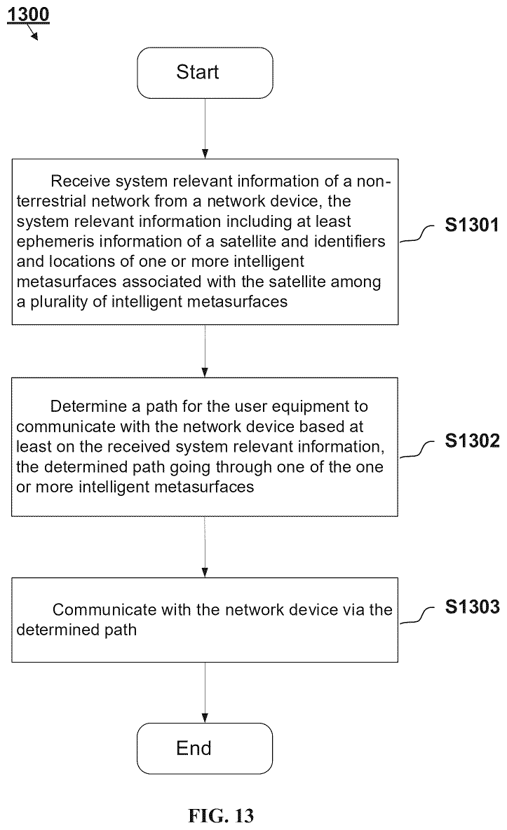

FIG. 13 illustrates a flowchart of an example method 1300 for a user equipment (or more specifically, an electronic device 300) in a non-terrestrial network according to an embodiment of the present disclosure. As shown in FIG. 13, the method 1300 may include a user equipment receiving system relevant information of a non-terrestrial network from a network device (block S1301). The system relevant information may include at least ephemeris information of a satellite, and identifiers and locations of one or more intelligent metasurfaces associated with the satellite among a plurality of intelligent metasurfaces. At block S1302, the user equipment may determine a path for the user equipment to communicate with the network device based at least on the received system relevant information. In the method, the determined path goes through one of the one or more intelligent metasurfaces. Thereafter, the user equipment may communicate with the network device via the determined path (block 1303). Detailed example operations of the method may refer to the above description of the operations of the user equipment (or more specifically, the electronic device 300), which will not be repeated here.

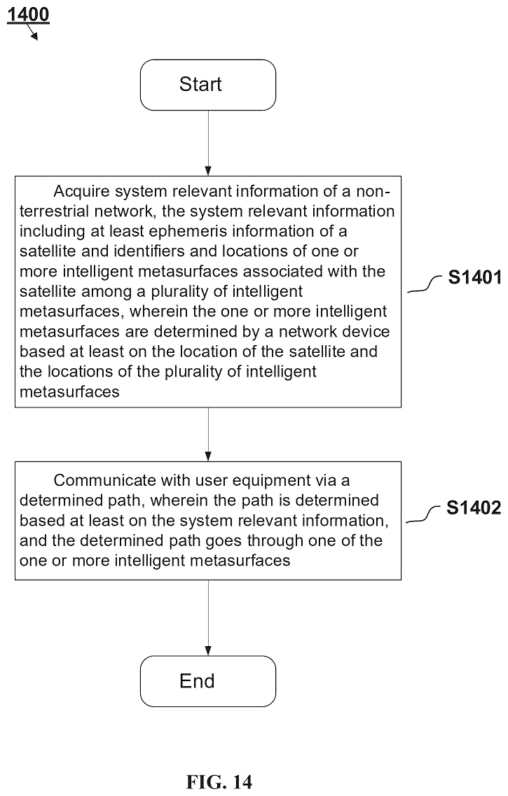

FIG. 14 illustrates a flowchart of an example method 1400 for a network device (or more specifically, an electronic device 400) in a non-terrestrial network according to an embodiment of the present disclosure. As shown in FIG. 14, the method 1400 may include the network device acquiring system relevant information of the non-terrestrial network (block 1401). The system relevant information includes at least ephemeris information of a satellite, and identifiers and locations of one or more intelligent metasurfaces associated with the satellite among a plurality of intelligent metasurfaces. In the method, the one or more intelligent metasurfaces are determined by the network device based at least on a location of the satellite and the locations of the plurality of intelligent metasurfaces. Thereafter, at block 1402, the network device may communicate with the user equipment via a determined path. In the method, the above path is determined (by the network device or the user equipment) at least based on the system relevant information, and the determined path goes through one of the one or more intelligent metasurfaces. Detailed example operations of the method may refer to the above description of the operations of the network device (or more specifically, the electronic device 400), which will not be repeated here.

The solution of the present disclosure may be implemented in the following exemplary ways.

Clause 1. An electronic device for a user equipment in a non-terrestrial network, the non-terrestrial network further comprising a network device capable of communicating with the user equipment, a satellite, and a plurality of intelligent metasurfaces, the electronic device comprising a processing circuit configured to cause the user equipment to:
receive system relevant information of the non-terrestrial network from the network device, the system relevant information including at least ephemeris information of the satellite, and identifiers and locations of one or more intelligent metasurfaces associated with the satellite among the plurality of intelligent metasurfaces;
determine a path for the user equipment to communicate with the network device based at least on the received system relevant information, the determined path going through one intelligent metasurface of the one or more intelligent metasurfaces; and
communicate with the network device through the determined path.

Clause 2. The electronic device according to Clause 1, wherein the determined path is different from a path through which the user equipment receives a reference signal with the highest received signal quality.

Clause 3. The electronic device according to Clause 1, wherein the determined path is the same as a path through which the user equipment receives a reference signal with the highest received signal quality.

Clause 4. The electronic device according to Clause 2 or 3, wherein the processing circuit is further configured to cause the user equipment to:
receive a reference signal from the network device through each of a plurality of paths going through some or all of the one or more intelligent metasurfaces, respectively; and
record a received signal quality of the reference signal corresponding to each of the plurality of paths.

Clause 5. The electronic device according to Clause 4, wherein the determining a path for the user equipment to communicate with the network device based at least on the received system relevant information comprises: selecting one of the plurality of paths as the determined path based at least on the system relevant information and the recorded received signal quality corresponding to each of the plurality of paths.

Clause 6. The electronic device according to Clause 5, wherein the processing circuit is further configured to cause the user equipment to:
derive durations when the one or more intelligent metasurfaces are covered by the satellite from the system relevant information;
in response to determining that a difference between the highest received signal quality and the received signal quality corresponding to a first path of the plurality of paths is less than a first threshold, and the duration when an intelligent metasurface in the first path is covered by the satellite is greater than the duration when an intelligent metasurface in a path with the highest received signal quality is covered by the satellite and is greater than a second threshold, select the first path as the determined path.

Clause 7. The electronic device according to Clause 1, wherein the system relevant information is included in a system information block (SIB).

Clause 8. The electronic device according to Clause 1, wherein the determining a path for the user equipment to communicate with the network device is performed before the user equipment accesses the non-terrestrial network, and the processing circuit is further configured to cause the user equipment to:
after the user equipment accesses the non-terrestrial network, performing, preferentially with a beam directed toward the one intelligent metasurface, one or more of: beam scanning, data reception, or beam recovery.

Clause 9. The electronic device according to Clause 4, wherein:
the system relevant information is included in beam scanning predetermined information; and
time-frequency resources corresponding to the reference signal are specified by the beam scanning predetermined information.

Clause 10. The electronic device according to Clause 4, wherein the reference signal comprises a synchronization signal block (SSB) or a channel state information reference signal (CSI-RS).

Clause 11. The electronic device according to Clause 1, wherein the processing circuit is further configured to cause the user equipment to:
switching from the network device to another network device; and
sending information of an intelligent metasurface in the determined path to the another network device, the information including at least the identifier and location of the intelligent metasurface, so that the another network device selects a switched path for communication based at least on the information, or instructs the user equipment to select the switched path.

Clause 12. The electronic device according to Clause 1, wherein the intelligent metasurface comprises a Large Intelligent Surface Antenna (LISA) or a Reconfigurable Intelligent Surface (RIS).

Clause 13. The electronic device according to Clause 1, wherein the system relevant information further comprises: gains of the one or more intelligent metasurfaces.

Clause 14. The electronic device according to Clause 1, wherein:
the one or more intelligent metasurfaces are determined by the network device based at least on the location of the satellite and the locations of the plurality of intelligent metasurfaces.

Clause 15. An electronic device for a network device in a non-terrestrial network, the non-terrestrial network further comprising a user equipment capable of communicating with the network device, a satellite, and a plurality of intelligent metasurfaces, the electronic device comprising a processing circuit configured to cause the network device to:
acquire system relevant information of the non-terrestrial network, the system relevant information including at least ephemeris information of the satellite, and identifiers and locations of one or more intelligent metasurfaces associated with the satellite among the plurality of intelligent metasurfaces, wherein the one or more intelligent metasurfaces are determined by the network device based at least on the location of the satellite and the locations of the plurality of intelligent metasurfaces; and
communicate with the user equipment via a determined path, wherein the path is determined based at least on the system relevant information, and the determined path goes through one intelligent metasurface of the one or more intelligent metasurfaces.

Clause 16. The electronic device according to Clause 15, wherein the determined path is different from a path through which the user equipment receives a reference signal from the network device with the highest received signal quality.

Clause 17. The electronic device according to Clause 15, wherein the determined path is the same as a path through which the user equipment receives a reference signal from the network device with the highest received signal quality.

Clause 18. The electronic device according to Clause 16 or 17, wherein the processing circuit is further configured to cause the network device to:
transmit a reference signal to the user equipment through each of a plurality of paths going through some or all of the one or more intelligent metasurfaces, respectively, wherein the user equipment records a received signal quality corresponding to each of the plurality of paths.

Clause 19. The electronic device according to Clause 18, wherein the processing circuit is further configured to cause the network device to:
receive, from the user equipment, a report on the received signal quality of the reference signal corresponding to each of the plurality of paths; and
select one of the plurality of paths as the determined path based at least on the system relevant information and the reported received signal quality.

Clause 20. The electronic device according to Clause 19, wherein the processing circuit is further configured to cause the network device to:
derive durations when the one or more intelligent metasurfaces are covered by the satellite through the system relevant information; and
in response to determining that a difference between the highest received signal quality and a received signal quality corresponding to a first path of the plurality of paths is less than a first threshold, and the duration when an intelligent metasurface in the first path is covered by the satellite is greater than the duration when an intelligent metasurface in the path with the highest received signal quality is covered by the satellite and is greater than a second threshold, select the first path as the determined path.

Clause 21. The electronic device according to Clause 18, wherein the processing circuit is further configured to cause the network device to:
send the system relevant information to the user equipment, so that the user equipment selects one of the plurality of paths as the determined path based at least on the system relevant information and the recorded received signal quality corresponding to each of the plurality of paths.

Clause 22. The electronic device according to Clause 15, wherein the system relevant information is included in a system information block (SIB).

Clause 23. The electronic device according to Clause 18, wherein:
the system relevant information is included in beam scanning predetermined information; and
time-frequency resources corresponding to the reference signal are specified by the beam scanning predetermined information.

Clause 24. The electronic device according to Clause 18, wherein the reference signal comprises a synchronization signal block (SSB) or a channel state information reference signal (CSI-RS).

Clause 25. The electronic device according to Clause 15, wherein another user equipment switches to the network device, and the processing circuit is further configured to cause the network device to:
receive, from the another user equipment, information of an intelligent metasurface in its previous path, the information including at least the identifier and location of the intelligent metasurface;
select a switched path based at least on the information, or instructing the another user equipment to select the switched path.

Clause 26. The electronic device according to Clause 15, wherein the intelligent metasurface comprises a Large Intelligent Surface Antenna (LISA) or a Reconfigurable Intelligent Surface (RIS).

Clause 27. The electronic device according to Clause 15, wherein the system relevant information further comprises: gains of the one or more intelligent metasurfaces.

Clause 28. A method for a user equipment in a non-terrestrial network, the non-terrestrial network further comprising a network device capable of communicating with the user equipment, a satellite, and a plurality of intelligent metasurfaces, the method comprising:
receiving system relevant information of the non-terrestrial network from the network device, the system relevant information including at least ephemeris information of the satellite, and identifiers and locations of one or more intelligent metasurfaces associated with the satellite among the plurality of intelligent metasurfaces;
determining a path for the user equipment to communicate with the network device based at least on the received system relevant information, the determined path going through one intelligent metasurface of the one or more intelligent metasurfaces; and
communicating with the network device through the determined path.

Clause 29. A method for a network device in a non-terrestrial network, the non-terrestrial network further comprising a user equipment capable of communicating with the network device, a satellite, and a plurality of intelligent metasurfaces, the method comprising:
acquiring system relevant information of the non-terrestrial network, the system relevant information including at least ephemeris information of the satellite, and identifiers and locations of one or more intelligent metasurfaces associated with the satellite among the multiple intelligent metasurfaces, wherein the one or more intelligent metasurfaces are determined by the network device based at least on the location of the satellite and the locations of the plurality of intelligent metasurfaces;
communicating with the user equipment through a determined path, wherein the path is determined based at least on the system relevant information, and the determined path goes through one intelligent metasurface of the one or more intelligent metasurfaces.

Clause 30. A computer-readable storage medium having one or more instructions stored thereon, which, when executed by one or more processors of an electronic device, cause the electronic device to perform the methods according to Clause 28 or 29.

Clause 31. A computer program product comprising program instructions which, when executed by one or more processors of a computer, cause the computer to perform the methods according to Clause 28 or 29.

It should be noted that the application examples described above are merely exemplary. The embodiments of the present disclosure may also be executed in any other appropriate manner in the above application examples, and the advantageous effects obtained by the embodiments of the present disclosure can still be achieved. Moreover, the embodiments of the present disclosure may also be applied to other similar application instances, and the advantageous effects obtained by the embodiments of the present disclosure can still be achieved.

It should be understood that machine-executable instructions in a machine-readable storage medium or program product according to embodiments of the present disclosure may be configured to perform operations corresponding to the device and method embodiments described above. When referring to the above device and method embodiments, the embodiments of the machine-readable storage medium or program product will be apparent to those skilled in the art, and therefore description thereof will not be repeated. Machine-readable storage media and program products for carrying or including the above machine-executable instructions also fall within the scope of the present disclosure. Such storage media may include, but are not limited to, floppy disks, optical disks, magneto-optical disks, memory cards, memory sticks, and the like.

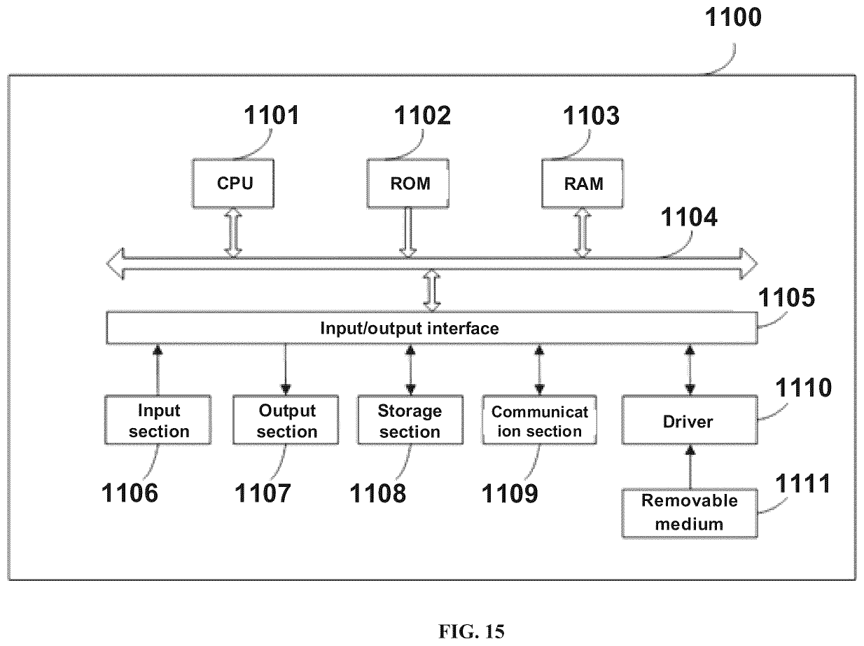

In addition, it should be understood that the above series of processes and devices may also be implemented by software and/or firmware. In a case of being implemented by software and/or firmware, a program constituting the software is installed from a storage medium or a network to a computer having a dedicated hardware structure, such as a general-purpose personal computer 1100 shown in FIG. 15, which, when is installed with various programs, may perform various functions and so on. FIG. 15 is a block diagram showing an example structure of a personal computer as an information processing device that may be employed in an embodiment of the present disclosure. In one example, the personal computer may correspond to the above exemplary terminal device according to the present disclosure.

In FIG. 15, a central processing unit (CPU) 1101 executes various processes according to a program stored in a read only memory (ROM) 1102 or a program loaded from a storage section 1108 to a random access memory (RAM) 1103. In the RAM 1103, data required when the CPU 1101 executes various processes and the like is also stored as necessary.

The CPU 1101, the ROM 1102, and the RAM 1103 are connected to each other via a bus 1104. Input/output interface 1105 is also connected to the bus 1104.

The following components are connected to the input/output interface 1105: an input section 1106 including a keyboard, mouse, etc.; an output section 1107 including a display such as a cathode ray tube (CRT), a liquid crystal display (LCD), etc., and a speaker, etc.; a storage section 1108 including a hard disk etc.; and a communication section 1109, including a network interface card such as a LAN card, a modem, etc. The communication section 1109 performs communication processing via a network such as the Internet.

The driver 1110 is also connected to the input/output interface 1105 as needed. A removable medium 1111 such as a magnetic disk, an optical disk, a magneto-optical disk, a semiconductor memory and the like is mounted on the drive 1110 as needed, so that a computer program read therefrom is installed into the storage section 1108 as needed.

In a case that the above series of processing is implemented by software, a program constituting the software is installed from a network such as the Internet or a storage medium such as a removable medium 1111.

It should be understood by those skilled in the art that such a storage medium is not limited to the removable medium 1111 shown in FIG. 15 in which a program is stored and distributed separately from the device to provide the program to the user. Examples of the removable media 1111 include magnetic disks (including floppy disks (registered trademark)), optical disks (including compact disk read only memory (CD-ROM) and digital versatile disks (DVD)), magneto-optical disks (including mini discs (MD) (registered trademark)) and semiconductor memories. Alternatively, the storage medium may be the ROM 1102, a hard disk included in the storage section 1108, or the like, in which programs are stored and distributed to users together with the devices containing them.

The techniques of the present disclosure may be applied to various products.

For example, the electronic device 400 according to an embodiment of the present disclosure may be implemented as or included in various network devices/base stations, while the method shown in FIG. 14 may also be implemented by various network devices/base stations. For example, the electronic devices 300 according to the embodiments of the present disclosure may be implemented as or included in various user equipments/devices, while the methods shown in FIG. 13 may also be implemented by various user equipments/terminal devices.

For example, the network device/base station mentioned in this disclosure may be implemented as any type of base station, e.g., an evolved Node B (gNB). The gNB may include one or more Transmit and Receive Points (TRPs). User equipment may connect to one or more TRPs within one or more gNBs. For example, a user equipment may be able to receive transmissions from a plurality of gNBs (and/or a plurality of TRPs provided by the same gNB). For example, The gNB may include a macro gNB and a small gNB. The small gNBs may be a gNB covering a cell smaller than macro cell, such as a pico gNB, a micro gNB, and a home (femto) gNB. Alternatively, the base station may be implemented as any other type of base station, such as a NodeB and a Base Transceiver Station (BTS). The base station may include: a body (also referred to as a base station device) configured to control wireless communication; and one or more Remote Radio Heads (RRHs) disposed at a different place from the body. In addition, various types of terminals to be described below may each operate as a base station by temporarily or semi-persistently performing base station functions.

For example, the user equipments mentioned in this disclosure, also referred to as terminal devices in some examples, may be implemented as mobile terminals (such as smart phones, tablet personal computers (PCs), notebook PCs, portable game terminals, portable/dongle-type mobile routers and digital cameras) or in-vehicle terminals (such as car navigation devices). The user equipments may also be implemented as terminals performing machine-to-machine (M2M) communication (also referred to as machine type communication (MTC) terminals). Furthermore, the user equipments may be wireless communication modules (such as integrated circuit modules comprising a single die) mounted on each of the above terminals. In some cases, the user equipments may communicate using a variety of wireless communication technologies. For example, the user equipments may be configured to communicate using two or more of GSM, UMTS, CDMA2000, WiMAX, LTE, LTE-A, WLAN, NR, Bluetooth, and the like. In some cases, the user equipments may also be configured to communicate using only one wireless communication technology.

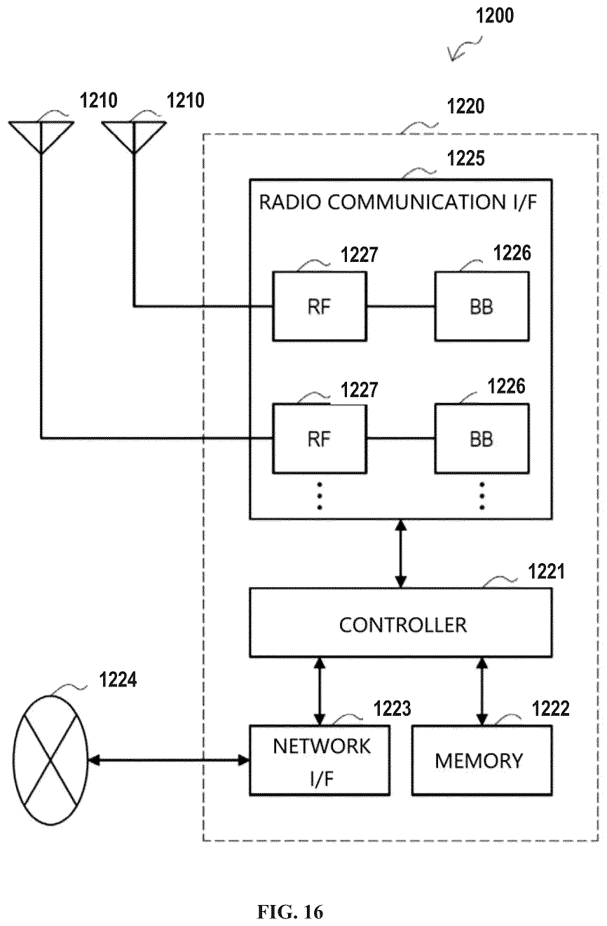

Examples according to the present disclosure will be described below with reference to FIGS. 16 to 19.

### Examples of Base Stations

It should be understood that the term base station in this disclosure has the full breadth of its ordinary meaning and includes at least a wireless communication station used as part of a wireless communication system or a radio system to facilitate communication. Examples of base stations may be, for example, but not limited to: a base station may be one or both of a base transceiver station (BTS) and a base station controller (BSC) in a GSM system, may be one or both of a radio network controller (RNC) and Node B in a WCDMA system, may be an eNB in a LTE and LTE-Advanced system, or may be a corresponding network node in a future communication system (for example, a gNB, an eLTE eNB and the like that may appear in a 5G communication system). Some functions in the base stations of the present disclosure may also be implemented as entities with control functions to communication in D2D, M2M and V2V communication scenarios, or as entities with spectrum coordination functions in cognitive radio communication scenarios.

### First Example

FIG. 16 is a block diagram showing a first example of a schematic configuration of a base station (a gNB is taken as an example in this figure) to which the technology of the present disclosure may be applied. The gNB 1200 includes multiple antennas 1210 and a base station device 1220. The base station device 1220 and each antenna 1210 may be connected to each other via an RF cable. In one implementation, the gNB 1200 (or the base station device 1220) here may correspond to the above network device (or more specifically, the electronic device 400).

Each of the antennas 1210 includes a single or multiple antenna elements (such as multiple antenna elements included in a multiple-input multiple-output (MIMO) antenna), and is used by the base station device 1220 to transmit and receive wireless signals. As shown in FIG. 16, the gNB 1200 may include multiple antennas 1210. For example, the multiple antennas 1210 may be compatible with multiple frequency bands used by the gNB 1200.

The base station device 1220 includes a controller 1221, a memory 1222, a network interface 1223, and a radio communication interface 1225.

The controller 1221 may be, for example, a CPU or a DSP, and operates various functions of a higher layer of the base station device 1220. For example, the controller 1221 generates data packets from the data in the signal processed by the radio communication interface 1225, and delivers the generated packets via the network interface 1223. The controller 1221 may bundle data from a plurality of baseband processors to generate a bundled packet, and deliver the generated bundled packet. The controller 1221 may have logical functions to perform controls such as radio resource control, radio bearer control, mobility management, admission control, and scheduling. These controls may be performed in conjunction with nearby gNBs or core network nodes. The memory 1222 includes RAM and ROM, and stores programs executed by the controller 1221 and various types of control data (such as a terminal list, transmission power data, and scheduling data).

The network interface 1223 is a communication interface for connecting the base station device 1220 to the core network 1224. The controller 1221 may communicate with core network nodes or further gNBs via the network interface 1223. In this case, the gNB 1200 and core network nodes or other gNBs may be connected to each other through logical interfaces (such as S1 interface and X2 interface). The network interface 1223 may also be a wired communication interface or a wireless communication interface for wireless backhaul. If the network interface 1223 is a wireless communication interface, the network interface 1223 may use a higher frequency band for wireless communication than the frequency band used by the radio communication interface 1225.

The radio communication interface 1225 supports any cellular communication scheme (such as Long Term Evolution (LTE) and LTE-Advanced), and provides wireless connectivity to terminals located in cells of the gNB 1200 via the antenna 1210. The radio communication interface 1225 may generally include, for example, a baseband (BB) processor 1226 and RF circuit 1227. The BB processor 1226 may perform, for example, encoding/decoding, modulation/demodulation, and multiplexing/demultiplexing, and performs various types of signal processing in layers (for example, L1, Medium Access Control (MAC), Radio Link Control (RLC), and Packet Data Convergence Protocol (PDCP)). In place of the controller 1221, the BB processor 1226 may have some or all of the above logical functions. The BB processor 1226 may be a memory storing a communication control program, or a module including a processor and associated circuit configured to execute the program. Updating the program may cause the functionality of the BB processor 1226 to change. The module may be a card or blade that is inserted into a slot in the base station device 1220. Alternatively, the module may also be a chip mounted on a card or blade. Meanwhile, the RF circuit 1227 may include, for example, a mixer, a filter, and an amplifier, and transmit and receive wireless signals via the antenna 1210. Although FIG. 16 illustrates an example in which one RF circuit 1227 is connected to one antenna 1210, the present disclosure is not limited to this, instead, one RF circuit 1227 may connect multiple antennas 1210 at the same time.

As shown in FIG. 16, the radio communication interface 1225 may include multiple BB processors 1226. For example, the multiple BB processors 1226 may be compatible with multiple frequency bands used by the gNB 1200. As shown in FIG. 16, the radio communication interface 1225 may include multiple RF circuits 1227. For example, the multiple RF circuits 1227 may be compatible with multiple antenna elements. Although FIG. 16 illustrates an example in which the radio communication interface 1225 includes multiple BB processors 1226 and multiple RF circuits 1227, the radio communication interface 1225 may also include a single BB processor 1226 or a single RF circuit 1227.

### Second Example

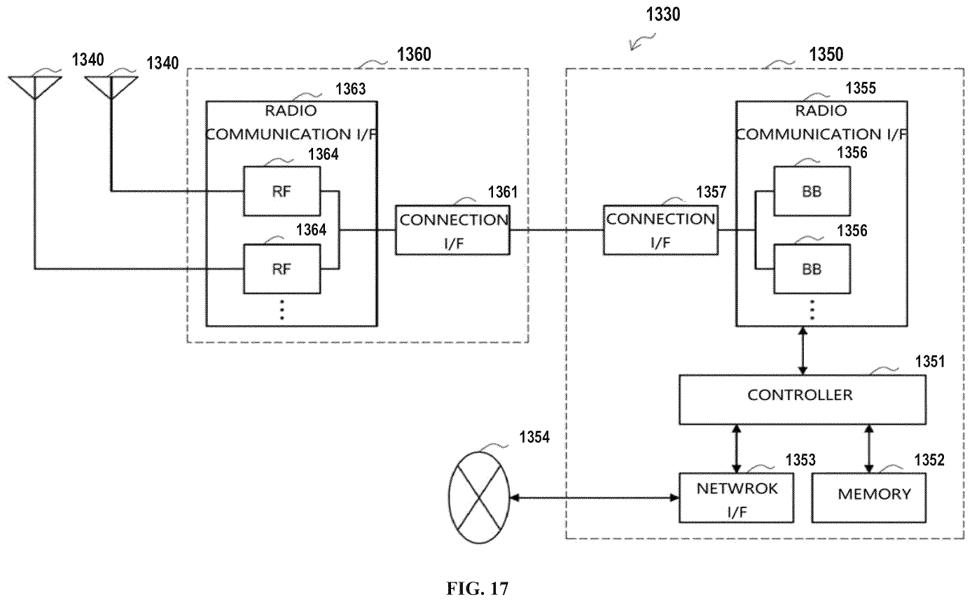

FIG. 17 is a block diagram showing a second example of a schematic configuration of a base station (a gNB is taken as an example in this figure) to which the technology of the present disclosure may be applied. The gNB 1330 includes multiple antennas 1340, a base station device 1350, and a RRH 1360. The RRH 1360 and each antenna 1340 may be connected to each other via an RF cable. The base station device 1350 and the RRH 1360 may be connected to each other via a high-speed line such as an optical fiber cable. In one implementation, the gNB 1330 (or the base station device 1350) here may correspond to the above network device (or more specifically, the electronic device 400).

Each of the antennas 1340 includes a single or multiple antenna elements (such as multiple antenna elements included in a MIMO antenna) and is used by the RRH 1360 to transmit and receive wireless signals. As shown in FIG. 17, the gNB 1330 may include multiple antennas 1340. For example, the multiple antennas 1340 may be compatible with multiple frequency bands used by the gNB 1330.

The base station device 1350 includes a controller 1351, a memory 1352, a network interface 1353, a radio communication interface 1355, and a connection interface 1357. The controller 1351, the memory 1352 and the network interface 1353 are the same as the controller 1221, the memory 1222 and the network interface 1223 described with reference to FIG. 16.

The radio communication interface 1355 supports any cellular communication scheme (such as LTE and LTE-Advanced), and provides wireless communication to terminals located in the sector corresponding to RRH 1360 via RRH 1360 and antenna 1340. The radio communication interface 1355 may generally include, for example, a BB processor 1356. The BB processor 1356 is the same as the BB processor 1226 described with reference to FIG. 16, except that the BB processor 1356 is connected to the RF circuit 1364 of the RRH 1360 via the connection interface 1357. As shown in FIG. 17, the radio communication interface 1355 may include multiple BB processors 1356. For example, the multiple BB processors 1356 may be compatible with multiple frequency bands used by the gNB 1330. Although FIG. 17 illustrates an example in which the radio communication interface 1355 includes multiple BB processors 1356, the radio communication interface 1355 may include a single BB processor 1356.

The connection interface 1357 is an interface for connecting the base station device 1350 (the radio communication interface 1355) to the RRH 1360. The connection interface 1357 may also be a communication module for communication in the above high-speed line connecting the base station device 1350 (the radio communication interface 1355) to the RRH 1360.

The RRH 1360 includes a connection interface 1361 and a radio communication interface 1363.

The connection interface 1361 is an interface for connecting the RRH 1360 (the radio communication interface 1363) to the base station device 1350. The connection interface 1361 may also be a communication module for communication in the above high-speed line.

The radio communication interface 1363 transmits and receives wireless signals via the antenna 1340. The radio communication interface 1363 may typically include an RF circuit 1364, for example. The RF circuit 1364 may include, for example, a mixer, a filter, and an amplifier, and transmit and receive wireless signals via antenna 1340. Although FIG. 17 illustrates an example in which one RF circuit 1364 is connected to one antenna 1340, the present disclosure is not limited to this, instead, one RF circuit 1364 may be connected to multiple antennas 1340 at the same time.

As shown in FIG. 17, the radio communication interface 1363 may include multiple RF circuits 1364. For example, the multiple RF circuits 1364 may support multiple antenna elements. Although FIG. 17 illustrates an example in which the radio communication interface 1363 includes multiple RF circuits 1364, the radio communication interface 1363 may include a single RF circuit 1364.

### Examples for User Equipments

### First Example

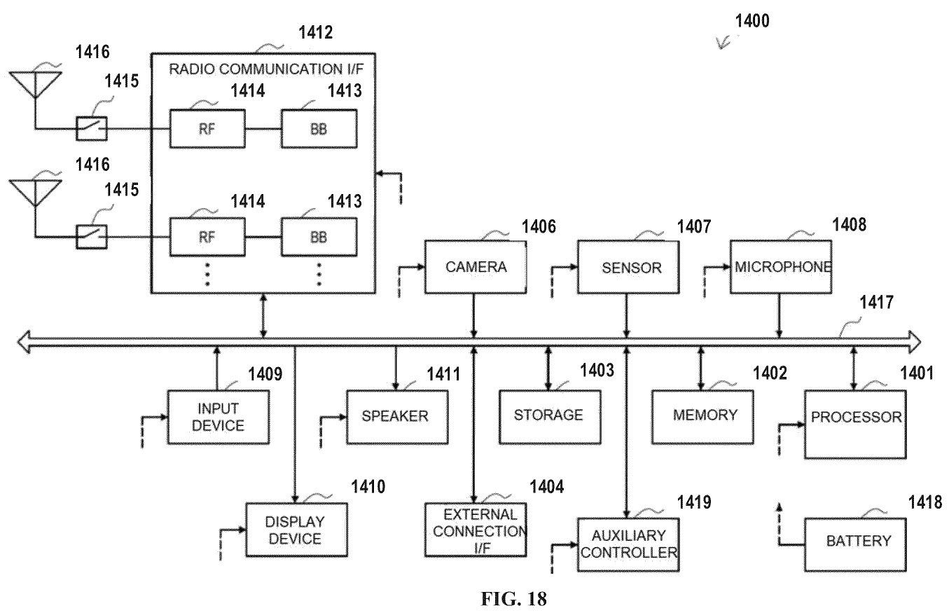

FIG. 18 is a block diagram showing an example of a schematic configuration of a smart phone 1400 to which the techniques of the present disclosure may be applied. The smart phone 1400 includes a processor 1401, a memory 1402, a storage apparatus 1403, an external connection interface 1404, a camera apparatus 1406, a sensor 1407, a microphone 1408, an input apparatus 1409, a display apparatus 1410, a speaker 1411, a radio communication interface 1412, one or more antenna switches 1415, one or more antennas 1416, a bus 1417, a battery 1418, and an auxiliary controller 1419. In one implementation, the smart phone 1400 (or the processor 1401) here may correspond to the above user equipment (or more specifically, the electronic devices 300).

The processor 1401 may be, for example, a CPU or a system on a chip (SoC), and controls functions of the application layer and further layers of the smart phone 1400. The memory 1402 includes RAM and ROM, and stores data and programs executed by the processor 1401. The storage apparatus 1403 may include a storage medium such as a semiconductor memory and a hard disk. The external connection interface 1404 is an interface for connecting an external apparatus (such as a memory card and a Universal Serial Bus (USB) apparatus) to the smart phone 1400.

The camera apparatus 1406 includes an image sensor (such as a charge coupled device (CCD) and a complementary metal oxide semiconductor (CMOS)), and generates captured images. The sensor 1407 may include a set of sensors, such as measurement sensors, gyroscope sensors, geomagnetic sensors, and acceleration sensors. The microphone 1408 converts the sound input to the smart phone 1400 into an audio signal. The input apparatus 1409 includes, for example, a touch sensor configured to detect a touch on the screen of the display apparatus 1410, a keypad, a keyboard, a button, or a switch, and receives operations or information input from a user. The display apparatus 1410 includes a screen (such as a liquid crystal display (LCD) and an organic light emitting diode (OLED) display), and displays an output image of the smart phone 1400. The speaker 1411 converts an audio signal output from the smart phone 1400 into sound.

The radio communication interface 1412 supports any cellular communication scheme (such as LTE and LTE-Advanced), and performs wireless communication. The radio communication interface 1412 may generally include, for example, a BB processor 1413 and an RF circuit 1414. The BB processor 1413 may perform, for example, encoding/decoding, modulation/demodulation, and multiplexing/demultiplexing, and perform various types of signal processing for wireless communication. Meanwhile, the RF circuit 1414 may include, for example, a mixer, a filter, and an amplifier, and transmit and receive wireless signals via the antenna 1416. The radio communication interface 1412 may be a chip module on which the BB processor 1413 and the RF circuit 1414 are integrated. As shown in FIG. 18, the radio communication interface 1412 may include multiple BB processors 1413 and multiple RF circuits 1414. Although FIG. 18 illustrates an example in which the radio communication interface 1412 includes multiple BB processors 1413 and multiple RF circuits 1414, the radio communication interface 1412 may include a single BB processor 1413 or a single RF circuit 1414.

Furthermore, in addition to cellular communication schemes, the radio communication interface 1412 may support additional types of wireless communication schemes, such as short-range wireless communication schemes, near field communication schemes, and wireless local area network (LAN) schemes. In this case, the radio communication interface 1412 may include a BB processor 1413 and an RF circuit 1414 for each wireless communication scheme.

Each of the antenna switches 1415 switches the connection destination of the antenna 1416 among a plurality of circuits (e.g., circuits for different wireless communication schemes) included in the radio communication interface 1412.

Each of the antennas 1416 includes a single or multiple antenna elements (such as multiple antenna elements included in a MIMO antenna), and is used for the radio communication interface 1412 to transmit and receive wireless signals. As shown in FIG. 18, the smart phone 1400 may include multiple antennas 1416. Although FIG. 18 illustrates an example in which the smart phone 1400 includes multiple antennas 1416, the smart phone 1400 may also include a single antenna 1416.

Furthermore, the smart phone 1400 may include an antenna 1416 for each wireless communication scheme. In this case, the antenna switch 1415 may be omitted from the configuration of the smart phone 1400.

The bus 1417 connects the processor 1401, the memory 1402, the storage apparatus 1403, the external connection interface 1404, the camera apparatus 1406, the sensor 1407, the microphone 1408, the input apparatus 1409, the display apparatus 1410, the speaker 1411, the radio communication interface 1412, and the auxiliary controller 1419 to each other. The battery 1418 provides power to the various blocks of the smart phone 1400 shown in FIG. 18 via feeders, which are partially shown in dashed lines in the figure. The auxiliary controller 1419 operates the minimum necessary functions of the smart phone 1400, e.g., in sleep mode.

### Second Example

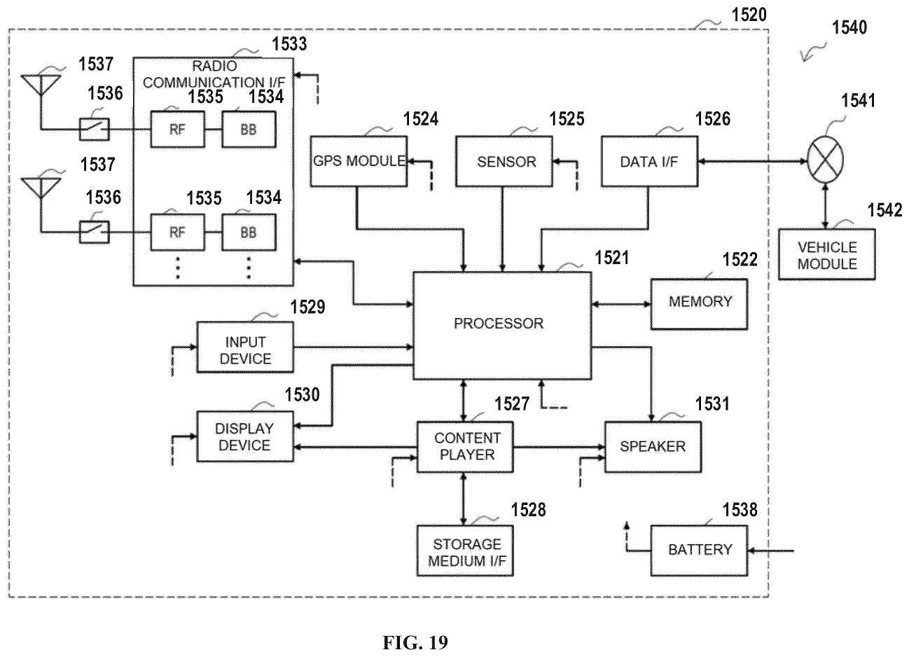

FIG. 19 is a block diagram showing an example of a schematic configuration of a car navigation device 1520 to which the technology of the present disclosure may be applied. The car navigation device 1520 includes a processor 1521, a memory 1522, a global positioning system (GPS) module 1524, a sensor 1525, a data interface 1526, a content player 1527, a storage medium interface 1528, an input apparatus 1529, a display apparatus 1530, a speaker 1531, a radio communication interface 1533, one or more antenna switches 1536, one or more antennas 1537, and a battery 1538. In one implementation, the car navigation device 1520 (or the processor 1521) here may correspond to the above user equipment (or more specifically, the electronic device 300).

The processor 1521 may be, for example, a CPU or a SoC, and controls the navigation function and other functions of the car navigation device 1520. The memory 1522 includes RAM and ROM, and stores data and programs executed by the processor 1521.

The GPS module 1524 uses GPS signals received from GPS satellites to measure the location (such as latitude, longitude, and altitude) of the car navigation device 1520. The sensor 1525 may include a set of sensors such as a gyroscope sensor, a geomagnetic sensor, and an air pressure sensor. The data interface 1526 is connected to, for example, an in-vehicle network 1541 via a terminal not shown, and acquires data (such as vehicle speed data) generated by the vehicle.

The content player 1527 reproduces content stored in storage media (such as CDs and DVDs), which are inserted into the storage media interface 1528. The input apparatus 1529 includes, for example, a touch sensor configured to detect a touch on the screen of the display apparatus 1530, a button, or a switch, and receives operations or information input from a user. The display apparatus 1530 includes a screen such as an LCD or OLED display, and displays images of a navigation function or reproduced content. The speaker 1531 outputs the sound of the navigation function or the reproduced content.

The radio communication interface 1533 supports any cellular communication scheme (such as LTE and LTE-Advanced), and performs wireless communication. The radio communication interface 1533 may generally include, for example, BB processor 1534 and RF circuit 1535. The BB processor 1534 may perform, for example, encoding/decoding, modulation/demodulation, and multiplexing/demultiplexing, and perform various types of signal processing for wireless communication. Meanwhile, the RF circuit 1535 may include, for example, a mixer, a filter, and an amplifier, and transmit and receive wireless signals via the antenna 1537. The radio communication interface 1533 may also be a chip module on which the BB processor 1534 and the RF circuit 1535 are integrated. As shown in FIG. 19, the radio communication interface 1533 may include multiple BB processors 1534 and multiple RF circuits 1535. Although FIG. 19 illustrates an example in which the radio communication interface 1533 includes multiple BB processors 1534 and multiple RF circuits 1535, the radio communication interface 1533 may also include a single BB processor 1534 or a single RF circuit 1535.

Furthermore, in addition to the cellular communication scheme, the radio communication interface 1533 may support another type of wireless communication scheme, such as a short-range wireless communication scheme, a near field communication scheme, and a wireless LAN scheme. In this case, the radio communication interface 1533 may include the BB processor 1534 and the RF circuit 1535 for each wireless communication scheme.

Each of the antenna switches 1536 switches the connection destination of the antenna 1537 among a plurality of circuits (such as circuits for different wireless communication schemes) included in the radio communication interface 1533.

Each of the antennas 1537 includes a single or multiple antenna elements (such as multiple antenna elements included in a MIMO antenna), and is used for the radio communication interface 1533 to transmit and receive wireless signals. As shown in FIG. 19, the car navigation device 1520 may include multiple antennas 1537. Although FIG. 19 illustrates an example in which the car navigation device 1520 includes multiple antennas 1537, the car navigation device 1520 may also include a single antenna 1537.

Furthermore, the car navigation device 1520 may include an antenna 1537 for each wireless communication scheme. In this case, the antenna switch 1536 may be omitted from the configuration of the car navigation device 1520.

The battery 1538 provides power to various blocks of the car navigation device 1520 shown in FIG. 19 via feeders, which are partially shown in dashed lines in the figure. The battery 1538 accumulates power supplied from the vehicle.

The techniques of this disclosure may also be implemented as an in-vehicle system (or vehicle) 1540 including one or more blocks of the car navigation device 1520, the in-vehicle network 1541, and the vehicle module 1542. The vehicle module 1542 generates vehicle data (such as vehicle speed, engine speed, and fault information), and outputs the generated data to the in-vehicle network 1541.

The exemplary embodiments of the present disclosure have been described above with reference to the drawings, but the present disclosure is not of course limited to the above examples. Those skilled in the art may find various changes and modifications within the scope of the appended claims, and it should be understood that these changes and modifications will naturally fall within the technical scope of the present disclosure.

For example, a plurality of functions included in one unit in the above embodiments may be implemented by separate apparatus. Alternatively, the plurality of functions implemented by multiple units in the above embodiments may be implemented by separate apparatus, respectively. Additionally, one of the above functions may be implemented by multiple units. Needless to say, such a configuration is included in the technical scope of the present disclosure.

In this specification, the steps described in the flowchart include not only processes performed in time sequence in the stated order, but also processes performed in parallel or individually rather than necessarily in time sequence. Furthermore, even in the steps processed in time sequence, needless to say, the order may be appropriately changed.

Although the present disclosure and its advantages have been described in detail, it should be understood that various changes, substitutions and alterations may be made herein without departing from the spirit and scope of the disclosure as defined by the appended claims. Furthermore, the terms “comprise”, “include” or any other variation thereof in embodiments of the present disclosure are intended to encompass a non-exclusive inclusion, such that a process, method, article or device comprising a series of elements includes not only those elements, but also include other elements not expressly listed, or include elements inherent to such process, method, article or device. Without further limitation, an element defined by the phrase “comprising one . . . ” does not preclude the presence of additional identical elements in a process, method, article or device that includes the element.

1. An electronic device for a user equipment in a non-terrestrial network, the non-terrestrial network further comprising a network device capable of communicating with the user equipment, a satellite, and a plurality of intelligent metasurfaces, the electronic device comprising a processing circuit configured to cause the user equipment to:
receive system relevant information of the non-terrestrial network from the network device, the system relevant information including at least ephemeris information of the satellite, and identifiers and locations of one or more intelligent metasurfaces associated with the satellite among the plurality of intelligent metasurfaces;
determine a path for the user equipment to communicate with the network device based at least on the received system relevant information, the determined path going through one intelligent metasurface of the one or more intelligent metasurfaces; and
communicate with the network device through the determined path.

2. The electronic device according to claim 1, wherein the determined path is different from or the same as a path through which the user equipment receives a reference signal with the highest received signal quality.

3. (canceled)

4. The electronic device according to claim 2, wherein the processing circuit is further configured to cause the user equipment to:
receive a reference signal from the network device through each of a plurality of paths going through some or all of the one or more intelligent metasurfaces, respectively; and
record a received signal quality of the reference signal corresponding to each of the plurality of paths.

5. The electronic device according to claim 4, wherein the determining a path for the user equipment to communicate with the network device based at least on the received system relevant information comprises: selecting one of the plurality of paths as the determined path based at least on the system relevant information and the recorded received signal quality corresponding to each of the plurality of paths.

6. The electronic device according to claim 5, wherein the processing circuit is further configured to cause the user equipment to:
derive durations when the one or more intelligent metasurfaces are covered by the satellite from the system relevant information;
in response to determining that a difference between the highest received signal quality and the received signal quality corresponding to a first path of the plurality of paths is less than a first threshold, and the duration when an intelligent metasurface in the first path is covered by the satellite is greater than the duration when an intelligent metasurface in a path with the highest received signal quality is covered by the satellite and is greater than a second threshold, select the first path as the determined path.

7. The electronic device according to claim 1, wherein the system relevant information is included in a system information block (SIB).

8. The electronic device according to claim 1, wherein the determining a path for the user equipment to communicate with the network device is performed before the user equipment accesses the non-terrestrial network, and the processing circuit is further configured to cause the user equipment to:
after the user equipment accesses the non-terrestrial network, performing, preferentially with a beam directed toward the one intelligent metasurface, one or more of: beam scanning, data reception, or beam recovery.

9. The electronic device according to claim 4, wherein:
the system relevant information is included in beam scanning predetermined information; and
time-frequency resources corresponding to the reference signal are specified by the beam scanning predetermined information.

10. (canceled)

11. The electronic device according to claim 1, wherein the processing circuit is further configured to cause the user equipment to:
switching from the network device to another network device; and
sending information of an intelligent metasurface in the determined path to the another network device, the information including at least the identifier and location of the intelligent metasurface, so that the another network device selects a switched path for communication based at least on the information, or instructs the user equipment to select the switched path.

12. The electronic device according to claim 1, wherein the intelligent metasurface comprises a Large Intelligent Surface Antenna (LISA) or a Reconfigurable Intelligent Surface (RIS).

13. The electronic device according to claim 1, wherein the system relevant information further comprises: gains of the one or more intelligent metasurfaces.

14. The electronic device according to claim 1, wherein:
the one or more intelligent metasurfaces are determined by the network device based at least on the location of the satellite and the locations of the plurality of intelligent metasurfaces.

15. An electronic device for a network device in a non-terrestrial network, the non-terrestrial network further comprising a user equipment capable of communicating with the network device, a satellite, and a plurality of intelligent metasurfaces, the electronic device comprising a processing circuit configured to cause the network device to:
acquire system relevant information of the non-terrestrial network, the system relevant information including at least ephemeris information of the satellite, and identifiers and locations of one or more intelligent metasurfaces associated with the satellite among the plurality of intelligent metasurfaces, wherein the one or more intelligent metasurfaces are determined by the network device based at least on the location of the satellite and the locations of the plurality of intelligent metasurfaces; and
communicate with the user equipment via a determined path, wherein the path is determined based at least on the system relevant information, and the determined path goes through one intelligent metasurface of the one or more intelligent metasurfaces.

16. The electronic device according to claim 15, wherein the determined path is different from or the same as a path through which the user equipment receives a reference signal from the network device with the highest received signal quality.

17. (canceled)

18. The electronic device according to claim 16, wherein the processing circuit is further configured to cause the network device to:
transmit a reference signal to the user equipment through each of a plurality of paths going through some or all of the one or more intelligent metasurfaces, respectively, wherein the user equipment records a received signal quality corresponding to each of the plurality of paths.

19. The electronic device according to claim 18, wherein the processing circuit is further configured to cause the network device to:
receive, from the user equipment, a report on the received signal quality of the reference signal corresponding to each of the plurality of paths; and
select one of the plurality of paths as the determined path based at least on the system relevant information and the reported received signal quality.

20. The electronic device according to claim 19, wherein the processing circuit is further configured to cause the network device to:
derive durations when the one or more intelligent metasurfaces are covered by the satellite through the system relevant information; and
in response to determining that a difference between the highest received signal quality and a received signal quality corresponding to a first path of the plurality of paths is less than a first threshold, and the duration when an intelligent metasurface in the first path is covered by the satellite is greater than the duration when an intelligent metasurface in the path with the highest received signal quality is covered by the satellite and is greater than a second threshold, select the first path as the determined path.

21. The electronic device according to claim 18, wherein the processing circuit is further configured to cause the network device to:
send the system relevant information to the user equipment, so that the user equipment selects one of the plurality of paths as the determined path based at least on the system relevant information and the recorded received signal quality corresponding to each of the plurality of paths.

22. The electronic device according to claim 15, wherein the system relevant information is included in a system information block (SIB).

23. The electronic device according to claim 18, wherein:
the system relevant information is included in beam scanning predetermined information; and
time-frequency resources corresponding to the reference signal are specified by the beam scanning predetermined information.

24. (canceled)

25. The electronic device according to claim 15, wherein another user equipment switches to the network device, and the processing circuit is further configured to cause the network device to:
receive, from the another user equipment, information of an intelligent metasurface in its previous path, the information including at least the identifier and location of the intelligent metasurface;
select a switched path based at least on the information, or instructing the another user equipment to select the switched path.

26. The electronic device according to claim 15, wherein the intelligent metasurface comprises a Large Intelligent Surface Antenna (LISA) or a Reconfigurable Intelligent Surface (RIS).

27. The electronic device according to claim 15, wherein the system relevant information further comprises: gains of the one or more intelligent metasurfaces.

28.-31. (canceled)
